(19) United States
(12) Patent Application Publication
(10) Pub. No.: US 2016/0371368 A1
(43) Pub. Date: Dec. 22, 2016

(54) FACILITATING SEARCHES IN A SEMI-STRUCTURED DATABASE

(71) Applicant: QUALCOMM Incorporated, San Diego, CA (US)

(72) Inventors: Craig Matthew BROWN, New South Wales (AU); Michael William PADDON, Tokyo (JP); Matthew Christian DUGGAN, Tokyo (JP); Kento TARUI, Tokyo (JP); Xavier Claude FRANC, Sarthe (FR); Lei NI, Burwood (AU); Louis PAN, Lane Cove North (AU); Joel Timothy BEACH, Sydney (AU)

(21) Appl. No.: 14/864,562

(22) Filed: Sep. 24, 2015

Related U.S. Application Data
(60) Provisional application No. 62/181,011, filed on Jun. 17, 2015.

(51) Int. Cl. G06F 17/30; G06F 17/24

(52) U.S. Cl. CPC G06F 17/30637; G06F 17/248; G06F 17/30498; G06F 17/30011

(57) ABSTRACT

In an embodiment, search parameters in a series of search queries directed to a target node of a semi-structured database are categorized as frequently recurring parameters. A partial search query template is populated with shortcut information related to the search parameters, and then used to facilitate execution of a new search query that includes the same search parameters. In another embodiment, an index is generated that links search parameters that return intermediate search result values to search result values that are configured to be obtained when a search is conducted on the intermediate search result values. The index can be generated based upon monitoring of actual searches within the semi-structured database, or alternatively based upon an inspection of the semi-structured database itself.

### CROSS-REFERENCE TO RELATED APPLICATION

The present Application for Patent claims the benefit of U.S. Provisional Application No. 62/181,011, entitled “FACILITATING SEARCHES IN A SEMI-STRUCTURED DATABASE”, filed Jun. 17, 2015, assigned to the assignee hereof, and expressly incorporated herein by reference in its entirety.

### BACKGROUND

1. Field

This disclosure relates to facilitating searches in a semi-structured database.

2. Description of the Related Art

Databases can store and index data in accordance with a structured data format (e.g., Relational Databases for normalized data queried by Structured Query Language (SQL), etc.), a semi-structured data format (e.g., XMLDBs for Extensible Markup Language (XML) data, RethinkDB for JavaScript Object Notation (JSON) data, etc.) or an unstructured data format (e.g., Key Value Stores for key-value data, ObjectDBs for object data, Solr for free text indexing, etc.). In structured databases, any new data objects to be added are expected to conform to a fixed or predetermined schema (e.g., a new Company data object may be required to be added with Name, Industry and Headquarters values, a new Bibliography data object may be required to be added with Author, Title, Journal and Date values, and so on). By contrast, in unstructured databases, new data objects can be added verbatim, so similar data objects can be added via different formats which may cause difficulties in establishing semantic relationships between the similar data objects.

Semi-structured databases share some properties with both structured and unstructured databases (e.g., similar data objects can be grouped together as in structured databases, while the various values of the grouped data objects are allowed to differ which is more similar to unstructured databases). Semi-structured database formats use a document structure that includes a plurality of nodes arranged in a tree hierarchy. The document structure includes any number of data objects that are each mapped to a particular node in the tree hierarchy, whereby the data objects are indexed either by the name of their associated node (i.e., flat-indexing) or by their unique path from a root node of the tree hierarchy to their associated node (i.e., label-path indexing). The manner in which the data objects of the document structure are indexed affects how searches (or queries) are conducted.

### SUMMARY

An example relates to a method of performing a search within a semi-structured database that is storing a set of documents, each document in the set of documents being organized with a tree-structure that contains a plurality of nodes, the plurality of nodes for each document in the set of documents including a root node and at least one non-root node, each of the plurality of nodes including a set of node-specific data entries. The example method may include obtaining a series of search queries directed to a given target node of a given document among the set of documents, categorizing a first set of search parameters in the series of search queries as frequently recurring parameters, generating a partial search query template that is populated with shortcut information related to the first set of search parameters, receiving a new search query that is directed to the given target node of the given document, detecting that the new search query includes the first set of search parameters, loading the partial search query template in response to the detecting and updating the loaded partial search query template to include one or more additional search parameters that are separate from the first set of search parameters and are specified in the new search query.

Another example relates to a server that is configured to perform a search within a semi-structured database that is storing a set of documents, each document in the set of documents being organized with a tree-structure that contains a plurality of nodes, the plurality of nodes for each document in the set of documents including a root node and at least one non-root node, each of the plurality of nodes including a set of node-specific data entries. The example server may include logic configured to obtain a series of search queries directed to a given target node of a given document among the set of documents, logic configured to categorize a first set of search parameters in the series of search queries as frequently recurring parameters, logic configured to generate a partial search query template that is populated with shortcut information related to the first set of search parameters, logic configured to receive a new search query that is directed to the given target node of the given document, logic configured to detect that the new search query includes the first set of search parameters, logic configured to load the partial search query template in response to the detection and logic configured to update the loaded partial search query template to include one or more additional search parameters that are separate from the first set of search parameters and are specified in the new search query.

Another example relates to a method of performing a search within a semi-structured database that is storing a set of documents, each document in the set of documents being organized with a tree-structure that contains a plurality of nodes, the plurality of nodes for each document in the set of documents including a root node and at least one non-root node, each of the plurality of nodes including a set of node-specific data entries. The example method includes beginning execution of a first search among the set of documents in the semi-structured database that is based on a first set of search parameters, obtaining, during the first search, a set of intermediate search result values, detecting that the first search requires execution of a second search that uses the set of intermediate search result values as a second set of search parameters for the second search, executing the second search in the semi-structured database using the set of intermediate search result values to obtain a set of second search result values, returning the set of second search result values as a final result of the first search, determining that the beginning, obtaining, detecting, executing and returning have occurred a threshold number of times and building, in response to the determining, an index that links a given search based on the first set of search parameters directly to the set of second search result values.

Another example relates to method of performing a search within a semi-structured database that is storing a set of documents, each document in the set of documents being organized with a tree-structure that contains a plurality of nodes, the plurality of nodes for each document in the set of documents including a root node and at least one non-root node, each of the plurality of nodes including a set of node-specific data entries. The example method may include inspecting the semi-structured database to detect a first set of values that, when returned as search result values for a first search in a first document among the set of documents, are configured to trigger a second search in the semi-structured database that uses the first set of values as search parameters for obtaining a second set of values that are returned as a final result of the first search and building an index that links a given search directed to the first set of values directly to the second set of values.

### BRIEF DESCRIPTION OF THE DRAWINGS

A more complete appreciation of embodiments of the disclosure will be readily obtained as the same becomes better understood by reference to the following detailed description when considered in connection with the accompanying drawings which are presented solely for illustration and not limitation of the disclosure, and in which:

FIG. 1 illustrates a high-level system architecture of a wireless communications system in accordance with an embodiment of the disclosure.

FIG. 2 illustrates examples of user equipments (UEs) in accordance with embodiments of the disclosure.

FIG. 3 illustrates a communication device that includes logic configured to perform functionality in accordance with an embodiment of the disclosure.

FIG. 4 illustrates a server in accordance with an embodiment of the disclosure.

FIG. 5A illustrates an example of nodes in a tree hierarchy for a given document in accordance with an embodiment of the disclosure.

FIG. 5B illustrates an example of a context tree for the document depicted in FIG. 5A in accordance with an embodiment of the disclosure.

FIG. 5C illustrates another example of a context tree in accordance with another embodiment of the disclosure.

FIG. 6A illustrates a more detailed example of the tree hierarchy depicted in FIG. 5A in accordance with another embodiment of the disclosure.

FIG. 6B illustrates a flat element index for an XML database in accordance with an embodiment of the disclosure.

FIG. 6C illustrates a context tree for an XML database in accordance with an embodiment of the disclosure.

FIG. 7 illustrates a conventional process by which search queries are executed in a semi-structured database.

FIG. 8 illustrates a process of generating a partial search query template for a semi-structured database in accordance with an embodiment of the disclosure.

FIG. 9 illustrates an example implementation of the process of FIG. 8 in accordance with an embodiment of the disclosure.

FIG. 10 illustrates a conventional XML-specific process of executing an XPath query without foreign key indexes in a semi-structured database.

FIG. 11 illustrates a process of building an index for a reference (or pointer) contained in a search query in accordance with an embodiment of the disclosure.

FIG. 12 illustrates an XML-specific implementation example that explains one way in which a particular search query that includes one or more reference (or pointer) parameters can be converted into an index in accordance with an embodiment of the disclosure.

FIG. 13 illustrates a process of building an index for a reference (or pointer) based upon inspection of the semi-structured database in accordance with an embodiment of the disclosure.

FIG. 14 illustrates an example continuation of the processes of FIG. 11 or FIG. 13 in accordance with an embodiment of the disclosure.

### DETAILED DESCRIPTION

Aspects of the disclosure are disclosed in the following description and related drawings directed to specific embodiments of the disclosure. Alternate embodiments may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the disclosure” does not require that all embodiments of the disclosure include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A client device, referred to herein as a user equipment (UE), may be mobile or stationary, and may communicate with a wired access network and/or a radio access network (RAN). As used herein, the term “UE” may be referred to interchangeably as an “access terminal” or “AT”, a “wireless device”, a “subscriber device”, a “subscriber terminal”, a “subscriber station”, a “user terminal” or UT, a “mobile terminal”, a “mobile station” and variations thereof. In an embodiment, UEs can communicate with a core network via a RAN, and through the core network the UEs can be connected with external networks such as the Internet. Of course, other mechanisms of connecting to the core network and/or the Internet are also possible for the UEs, such as over wired access networks, WiFi networks (e.g., based on IEEE 802.11, etc.) and so on. UEs can be embodied by any of a number of types of devices including but not limited to cellular telephones, personal digital assistants (PDAs), pagers, laptop computers, desktop computers, PC cards, compact flash devices, external or internal modems, wireless or wireline phones, and so on. A communication link through which UEs can send signals to the RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

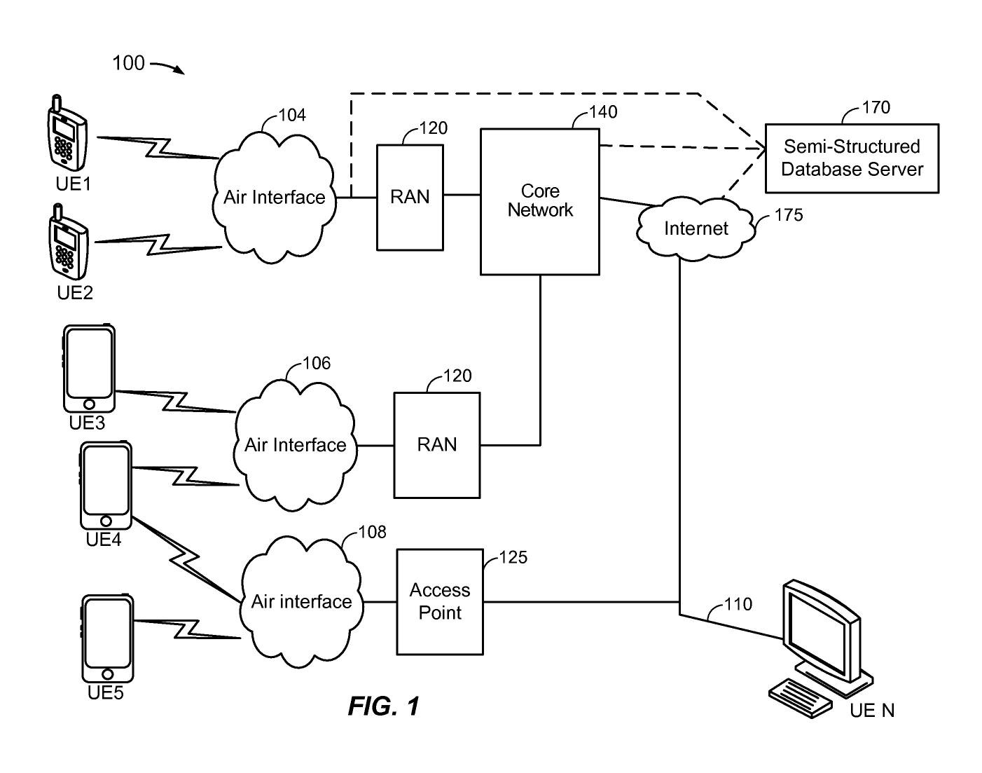

FIG. 1 illustrates a high-level system architecture of a wireless communications system 100 in accordance with an embodiment of the disclosure. The wireless communications system 100 contains UEs 1 . . . N. For example, in FIG. 1, UEs 1 . . . 2 are illustrated as cellular calling phones, UEs 3 . . . 5 are illustrated as cellular touchscreen phones or smart phones, and UE N is illustrated as a desktop computer or PC.

Referring to FIG. 1, UEs 1 . . . N are configured to communicate with an access network (e.g., a RAN 120, an access point 125, etc.) over a physical communications interface or layer, shown in FIG. 1 as air interfaces 104, 106, 108 and/or a direct wired connection 110. The air interfaces 104 and 106 can comply with a given cellular communications protocol (e.g., CDMA, EVDO, eHRPD, GSM, EDGE, W-CDMA, LTE, etc.), while the air interface 108 can comply with a wireless IP protocol (e.g., IEEE 802.11). The RAN 120 may include a plurality of access points that serve UEs over air interfaces, such as the air interfaces 104 and 106. The access points in the RAN 120 can be referred to as access nodes or ANs, access points or APs, base stations or BSs, Node Bs, eNode Bs, and so on. These access points can be terrestrial access points (or ground stations), or satellite access points. The RAN 120 may be configured to connect to a core network 140 that can perform a variety of functions, including bridging circuit-switched (CS) calls between UEs served by the RAN 120 and other UEs served by the RAN 120 or a different RAN altogether, and may also mediate an exchange of packet-switched (PS) data with external networks such as Internet 175.

The Internet 175, in some examples, includes a number of routing agents and processing agents (not shown in FIG. 1 for the sake of convenience). In FIG. 1, UE N is shown as connecting to the Internet 175 directly (i.e., separate from the core network 140, such as over an Ethernet connection of WiFi or 802.11-based network). The Internet 175 can thereby function to bridge packet-switched data communications between UEs 1 . . . N via the core network 140. Also shown in FIG. 1 is the access point 125 that is separate from the RAN 120. The access point 125 may be connected to the Internet 175 independent of the core network 140 (e.g., via an optical communications system such as FiOS, a cable modem, etc.). The air interface 108 may serve UE 4 or UE 5 over a local wireless connection, such as IEEE 802.11 in an example. UE N is shown as a desktop computer with a wired connection to the Internet 175, such as a direct connection to a modem or router, which can correspond to the access point 125 itself in an example (e.g., for a WiFi router with both wired and wireless connectivity).

Referring to FIG. 1, a semi-structured database server 170 is shown as connected to the Internet 175, the core network 140, or both. The semi-structured database server 170 can be implemented as a plurality of structurally separate servers (i.e., a distributed server arrangement), or alternately may correspond to a single server. The semi-structured database server 170 is responsible for maintaining a semi-structured database (e.g., an XML database, a JavaScript Object Notation (JSON) database, etc.) and executing search queries within the semi-structured database on behalf of one or more client devices, such as UEs 1 . . . N as depicted in FIG. 1. In some implementations, the semi-structured database server 170 can execute on one or more of the client devices as opposed to a network server, in which case the various client devices can interface with the semi-structured database server 170 via network connections as depicted in FIG. 1, or alternatively via local or peer-to-peer interfaces. In another example, the semi-structured database server 170 can run as an embedded part of an application on a device (e.g., a network server, a client device or UE, etc.). In this case, where the semi-structured database server 170 is implemented as an application that manages the semi-structured database, the application can operate without the need for inter-process communication between other applications on the device.

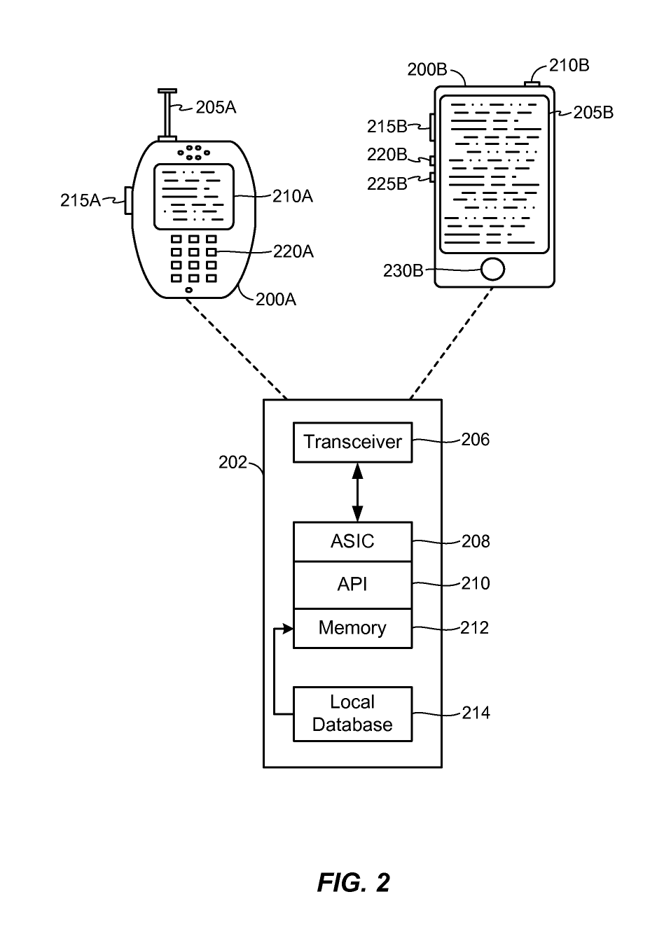

FIG. 2 illustrates examples of UEs (i.e., client devices) in accordance with embodiments of the disclosure. Referring to FIG. 2, UE 200A is illustrated as a calling telephone and UE 200B is illustrated as a touchscreen device (e.g., a smart phone, a tablet computer, etc.). As shown in FIG. 2, an external casing of UE 200A is configured with an antenna 205A, display 210A, at least one button 215A (e.g., a PTT button, a power button, a volume control button, etc.) and a keypad 220A among other components, as is known in the art. Also, an external casing of UE 200B is configured with a touchscreen display 205B, peripheral buttons 210B, 215B, 220B and 225B (e.g., a power control button, a volume or vibrate control button, an airplane mode toggle button, etc.), and at least one front-panel button 230B (e.g., a Home button, etc.), among other components, as is known in the art. While not shown explicitly as part of UE 200B, UE 200B can include one or more external antennas and/or one or more integrated antennas that are built into the external casing of UE 200B, including but not limited to WiFi antennas, cellular antennas, satellite position system (SPS) antennas (e.g., global positioning system (GPS) antennas), and so on.

While internal components of UEs such as UEs 200A and 200B can be embodied with different hardware configurations, a basic high-level UE configuration for internal hardware components is shown as platform 202 in FIG. 2. The platform 202 can receive and execute software applications, data and/or commands transmitted from the RAN 120 that may ultimately come from the core network 140, the Internet 175 and/or other remote servers and networks (e.g., the semi-structured database server 170, web URLs, etc.). The platform 202 can also independently execute locally stored applications without RAN interaction. The platform 202 can include a transceiver 206 operably coupled to an application specific integrated circuit (ASIC) 208, or other processor, microprocessor, logic circuit, or other data processing device. The ASIC 208 or other processor executes the application programming interface (API) 210 layer that interfaces with any resident programs in a memory 212 of the wireless device. The memory 212 can be comprised of read-only or random-access memory (RAM and ROM), EEPROM, flash cards, or any memory common to computer platforms. The platform 202 also can include a local database 214 that can store applications not actively used in the memory 212, as well as other data. The local database 214 is typically a flash memory cell, but can be any secondary storage device as known in the art, such as magnetic media, EEPROM, optical media, tape, soft or hard disk, or the like.

Accordingly, an embodiment of the disclosure can include a UE (e.g., UE 200A, 200B, etc.) including the ability to perform the functions described herein. As will be appreciated by those skilled in the art, the various logic elements can be embodied in discrete elements, software modules executed on a processor or any combination of software and hardware to achieve the functionality disclosed herein. For example, the ASIC 208, the memory 212, the API 210 and the local database 214 may all be used cooperatively to load, store and execute the various functions disclosed herein and thus the logic to perform these functions may be distributed over various elements. Alternatively, the functionality could be incorporated into one discrete component. Therefore, the features of UEs 200A and 200B in FIG. 2 are to be considered merely illustrative and the disclosure is not limited to the illustrated features or arrangement.

The wireless communications between UEs 200A and/or 200B and the RAN 120 can be based on different technologies, such as CDMA, W-CDMA, time division multiple access (TDMA), frequency division multiple access (FDMA), Orthogonal Frequency Division Multiplexing (OFDM), GSM, or other protocols that may be used in a wireless communications network or a data communications network. As discussed in the foregoing and known in the art, voice transmission and/or data can be transmitted to the UEs from the RAN using a variety of networks and configurations. Accordingly, the illustrations provided herein are not intended to limit the embodiments of the disclosure and are merely to aid in the description of aspects of embodiments of the disclosure.

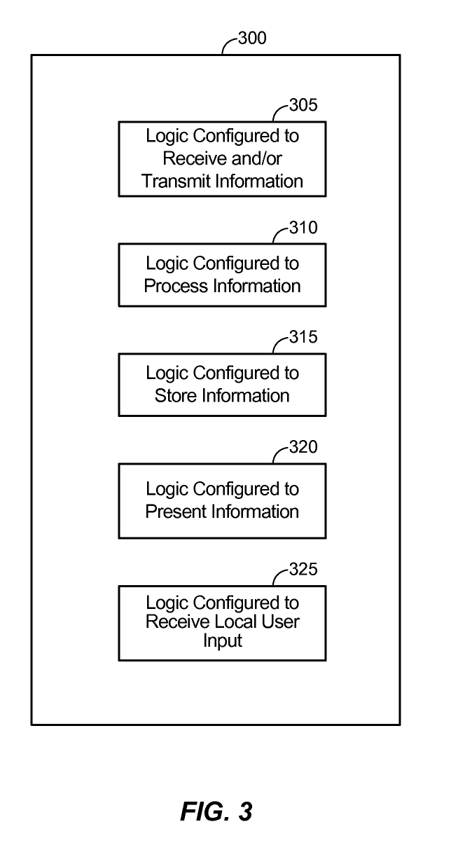

FIG. 3 illustrates a communications device 300 that includes logic configured to perform functionality in accordance with an embodiment of the disclosure. The communications device 300 can correspond to any of the above-noted communications devices, including but not limited to UEs 200A or 200B, any component of the RAN 120, any component of the core network 140, any components coupled with the core network 140 and/or the Internet 175 (e.g., the semi-structured database server 170), and so on. Thus, the communications device 300 can correspond to any electronic device that is configured to communicate with (or facilitate communication with) one or more other entities over the wireless communications system 100 of FIG. 1.

Referring to FIG. 3, the communications device 300 includes logic configured to receive and/or transmit information 305. In some embodiments such as when the communications device 300 corresponds to a wireless communications device (e.g., UE 200A or 200B, the access point 125, a BS, Node B or eNodeB in the RAN 120, etc.), the logic configured to receive and/or transmit information 305 can include a wireless communications interface (e.g., Bluetooth, WiFi, 2G, CDMA, W-CDMA, 3G, 4G, LTE, etc.) such as a wireless transceiver and associated hardware (e.g., an RF antenna, a MODEM, a modulator and/or demodulator, etc.). In another example, the logic configured to receive and/or transmit information 305 can correspond to a wired communications interface (e.g., a serial connection, a USB or Firewire connection, an Ethernet connection through which the Internet 175 can be accessed, etc.). For example, the communications device 300 may correspond to some type of network-based server (e.g., the semi-structured database server 170, etc.), and the logic configured to receive and/or transmit information 305 can correspond to an Ethernet card that connects the network-based server to other communication entities via an Ethernet protocol.

In a further example, the logic configured to receive and/or transmit information 305 can include sensory or measurement hardware by which the communications device 300 can monitor its local environment (e.g., an accelerometer, a temperature sensor, a light sensor, an antenna for monitoring local RF signals, etc.). The logic configured to receive and/or transmit information 305 can also include software that, when executed, permits the associated hardware of the logic configured to receive and/or transmit information 305 to perform its reception and/or transmission function(s). However, in various implementations, the logic configured to receive and/or transmit information 305 does not correspond to software alone, and the logic configured to receive and/or transmit information 305 relies at least in part upon hardware to achieve its functionality.

The communications device 300 of FIG. 3 may further include logic configured to process information 310. In an example, the logic configured to process information 310 can include at least a processor. Example implementations of the type of processing that can be performed by the logic configured to process information 310 includes but is not limited to performing determinations, establishing connections, making selections between different information options, performing evaluations related to data, interacting with sensors coupled to the communications device 300 to perform measurement operations, converting information from one format to another (e.g., between different protocols such as .wmv to .avi, etc.), and so on. For example, the processor included in the logic configured to process information 310 can correspond to a general purpose processor, a digital signal processor (DSP), an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The logic configured to process information 310 can also include software that, when executed, permits the associated hardware of the logic configured to process information 310 to perform its processing function(s). However, in various implementations, the logic configured to process information 310 does not correspond to software alone, and the logic configured to process information 310 relies at least in part upon hardware to achieve its functionality.

The communications device 300 of FIG. 3 may further include logic configured to store information 315. In an example, the logic configured to store information 315 can include at least a non-transitory memory and associated hardware (e.g., a memory controller, etc.). For example, the non-transitory memory included in the logic configured to store information 315 can correspond to RAM memory, flash memory, ROM memory, EPROM memory, EEPROM memory, registers, hard disk, a removable disk, a CD-ROM, or any other form of storage medium known in the art. The logic configured to store information 315 can also include software that, when executed, permits the associated hardware of the logic configured to store information 315 to perform its storage function(s). However, in various implementations, the logic configured to store information 315 does not correspond to software alone, and the logic configured to store information 315 relies at least in part upon hardware to achieve its functionality.

The communications device 300 of FIG. 3 may further include logic configured to present information 320. In an example, the logic configured to present information 320 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communications device 300. For example, if the communications device 300 corresponds to UE 200A or UE 200B as shown in FIG. 2, the logic configured to present information 320 can include the display 210A of UE 200A or the touchscreen display 205B of UE 200B. In a further example, the logic configured to present information 320 can be omitted for certain communications devices, such as network communications devices that do not have a local user (e.g., network switches or routers, remote servers such as the semi-structured database server 170, etc.). The logic configured to present information 320 can also include software that, when executed, permits the associated hardware of the logic configured to present information 320 to perform its presentation function(s). However, in various implementations, the logic configured to present information 320 does not correspond to software alone, and the logic configured to present information 320 relies at least in part upon hardware to achieve its functionality.

The communications device 300 of FIG. 3 may further include logic configured to receive local user input 325. In an example, the logic configured to receive local user input 325 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communications device 300. For example, if the communications device 300 corresponds to UE 200A or UE 200B as shown in FIG. 2, the logic configured to receive local user input 325 can include the keypad 220A, any of the buttons 215A or 210B through 225B, the touchscreen display 205B, etc. In a further example, the logic configured to receive local user input 325 can be omitted for certain communications devices, such as network communications devices that do not have a local user (e.g., network switches or routers, remote servers such as the semi-structured database server 170, etc.). The logic configured to receive local user input 325 can also include software that, when executed, permits the associated hardware of the logic configured to receive local user input 325 to perform its input reception function(s). However, in various implementations, the logic configured to receive local user input 325 does not correspond to software alone, and the logic configured to receive local user input 325 relies at least in part upon hardware to achieve its functionality.

Referring to FIG. 3, while the configured logics 305 through 325 are shown as separate or distinct blocks in FIG. 3, it will be appreciated that the hardware and/or software by which the respective configured logics 305 through 325 performs its functionality can overlap in part or as a whole. For example, any software used to facilitate the functionality of the configured logics 305 through 325 can be stored in the non-transitory memory associated with the logic configured to store information 315, such that the configured logics 305 through 325 each performs their functionality (i.e., in this case, software execution) based in part upon the operation of software stored by the logic configured to store information 315. Likewise, hardware that is directly associated with one of the configured logics 305 through 325 can be borrowed or used by other configured logics from time to time. For example, the processor of the logic configured to process information 310 can format data into an appropriate format before being transmitted by the logic configured to receive and/or transmit information 305, such that the logic configured to receive and/or transmit information 305 performs its functionality (i.e., in this case, transmission of data) based in part upon the operation of hardware (i.e., the processor) associated with the logic configured to process information 310.

Generally, unless stated otherwise explicitly, the phrase “logic configured to” as used throughout this disclosure is intended to invoke an embodiment that is at least partially implemented with hardware, and is not intended to map to software-only implementations that are independent of hardware. Also, it will be appreciated that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the embodiments described below in more detail.

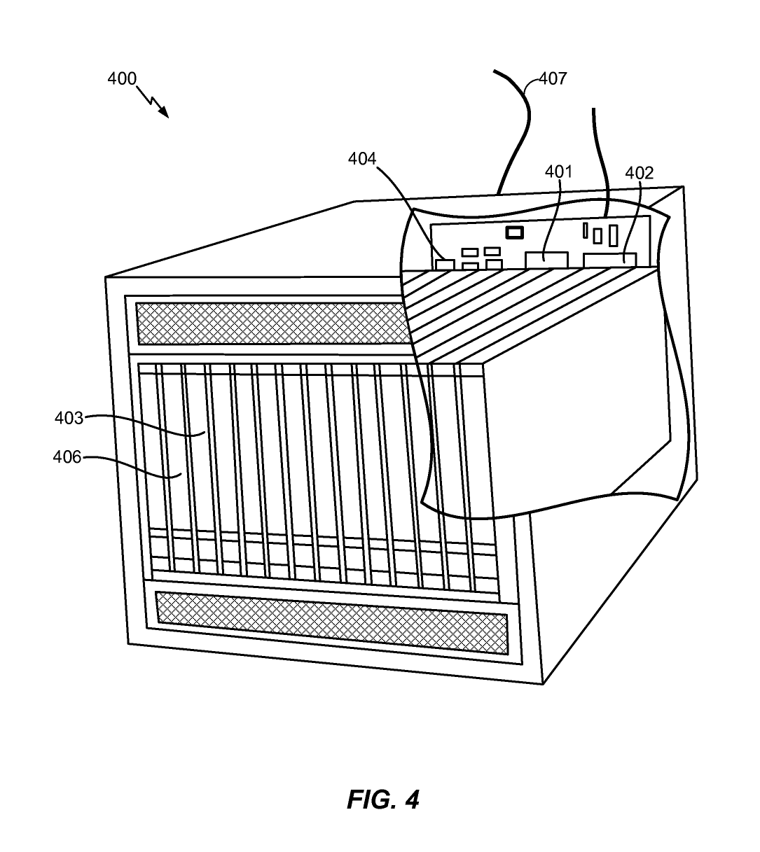

The various embodiments may be implemented on any of a variety of commercially available server devices, such as server 400 illustrated in FIG. 4. In an example, the server 400 may correspond to one example configuration of the semi-structured database server 170 described above. The server 400 may include a processor 401 coupled to a volatile memory 402 and a large capacity nonvolatile memory, such as a disk drive 403. The server 400 may also include a memory 406 (e.g., a floppy disc drive, compact disc (CD), a DVD disc drive, etc.) coupled to the processor 401. The server 400 may also include network access ports 404 coupled to the processor 401 for establishing data connections with a network via network connector 407, such as a local area network coupled to other broadcast system computers and servers or to the Internet. In context with FIG. 3, it will be appreciated that the server 400 of FIG. 4 illustrates one example implementation of the communications device 300, whereby the logic configured to transmit and/or receive information 305 corresponds to the network access ports 404 used by the server 400 to communicate via network connector 407, the logic configured to process information 310 corresponds to the processor 401, and the logic configured to store information 315 corresponds to any combination of the memory 406. The logic configured to present information 320 and the logic configured to receive local user input 325 are not shown explicitly in FIG. 4 and may or may not be included therein. Thus, FIG. 4 helps to demonstrate that the communications device 300 may be implemented as a server, in addition to a UE implementation as in FIG. 2.

Databases can store and index data in accordance with a structured data format (e.g., Relation Databases for normalized data queried by Structured Query Language (SQL), etc.), a semi-structured data format (e.g., XMLDBs for Extensible Markup Language (XML) data, RethinkDB for JavaScript Object Notation (JSON) data, etc.) or an unstructured data format (e.g., Key Value Stores for key-value data, ObjectDBs for object data, Solr for free text indexing, etc.). In structured databases, any new data objects to be added are expected to conform to a fixed or predetermined schema (e.g., a new Company data object may be required to be added with “Name”, “Industry” and “Headquarters” values, a new Bibliography data object may be required to be added with “Author”, “Title”, “Journal” and “Date” values, and so on). By contrast, in unstructured databases, new data objects are added verbatim, which permits similar data objects to be added via different formats which causes difficulties in establishing semantic relationships between the similar data objects.

Examples of structured database entries for a set of data objects may be configured as follows:

TABLE 1
Example of Structured Database Entry for a Company Data Object

| Name | Industry | Headquarters |
|---|---|---|
| Company X | Semiconductor; | San Diego, California, USA |
| | Wireless Telecommunications | |

whereby “Name”, “Industry” and “Headquarters” are predetermined values that are associated with each “Company”-type data object stored in the structured database, or

TABLE 2
Example of Structured Database Entry for Bibliography Data Objects

| Author | Title | Journal | Date |
|---|---|---|---|
| Cox, J. | Company X races to retool | Network World | 2007 |
| | the mobile phone | | |
| Arensman, | Meet the New Company X | Electronic Business | 2000 |
| Russ | | | |

whereby “Author”, “Title”, “Journal” and “Date” are predetermined values that are associated with each “Bibliography”-type data object stored in the structured database.

Examples of unstructured database entries for the set of data objects may be configured as follows:

TABLE 3
Example of Unstructured Database Entry for a Company Data Object

Company X is an American global semiconductor company that designs
and markets wireless telecommunications products and services. The
company headquarters are located in San Diego, California, USA.

TABLE 4
Example of Unstructured Database Entry for Bibliography Data Objects

Cox, J. (2007). ‘Company X races to retool the mobile phone’. Network
World, 24/8: 26.
Arensman, Russ. “Meet the New Company X.” Electronic Business,
Mar. 1, 2000.

As will be appreciated, the structured and unstructured databases in Tables 1 and 3 and in Tables 2 and 4 store substantially the same information, with the structured database having a rigidly defined value format for the respective class of data object while the unstructured database does not have defined values associated for data object classes.

Semi-structured databases share some properties with both structured and unstructured databases (e.g., similar data objects can be grouped together as in structured databases, while the various values of the grouped data objects are allowed to differ which is more similar to unstructured databases). Semi-structured database formats use a document structure that includes a set of one or more documents that each have a plurality of nodes arranged in a tree hierarchy. The plurality of nodes are generally implemented as logical nodes (e.g., the plurality of nodes can reside in a single memory and/or physical device), although it is possible that some of the nodes are deployed on different physical devices (e.g., in a distributed server environment) so as to qualify as both distinct logical and physical nodes. Each document includes any number of data objects that are each mapped to a particular node in the tree hierarchy, whereby the data objects are indexed either by the name of their associated node (i.e., flat-indexing) or by their unique path from a root node of the tree hierarchy to their associated node (i.e., label-path indexing). The manner in which the data objects of the document structure are indexed affects how searches (or queries) are conducted.

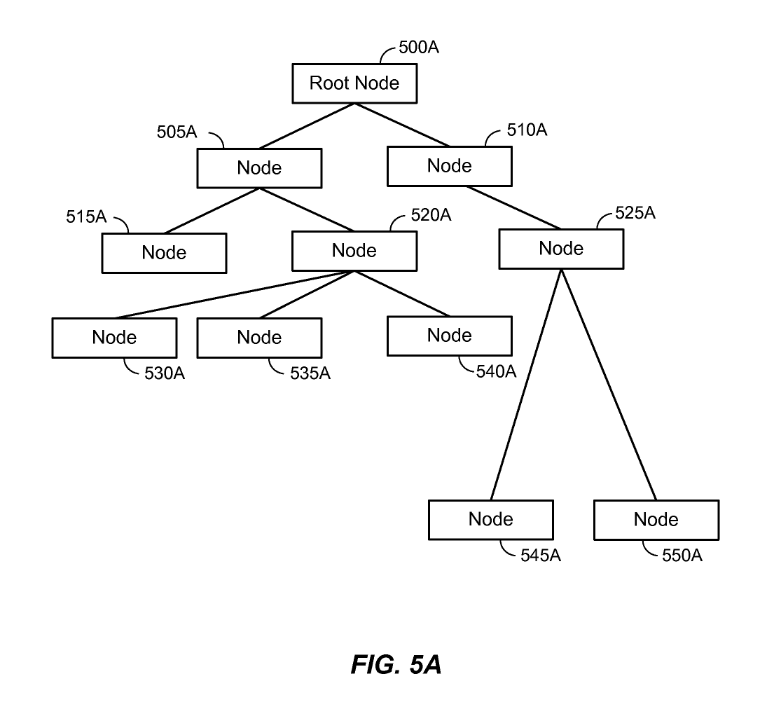

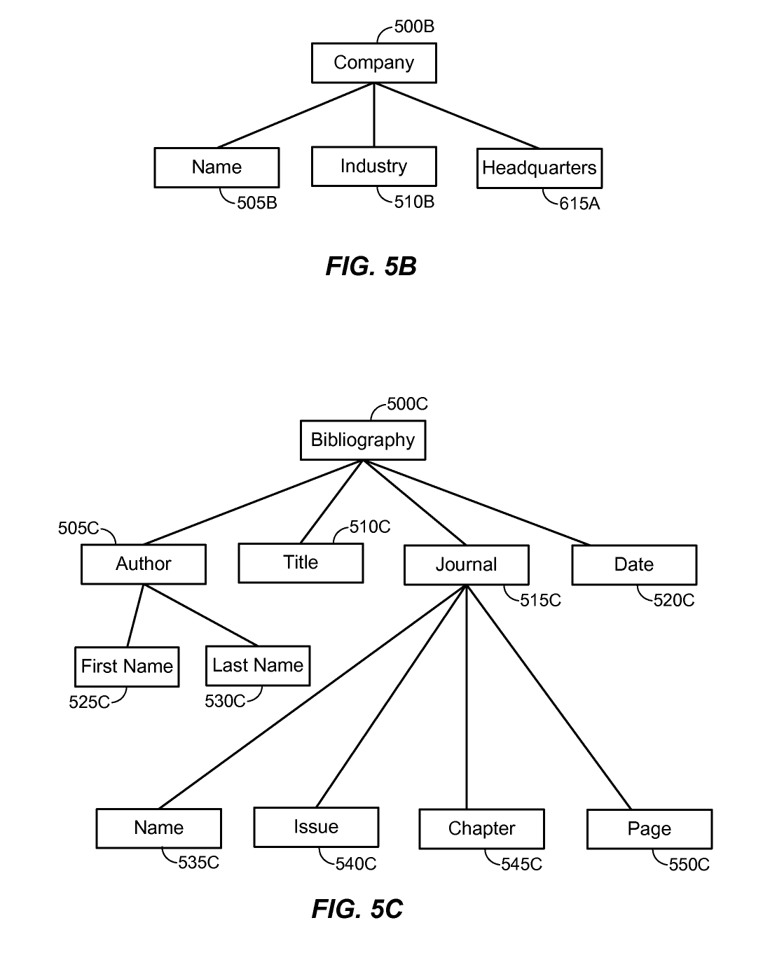

FIG. 5A illustrates a set of nodes in a tree hierarchy for a given document in accordance with an embodiment of the disclosure. As illustrated, a root node 500A contains descendant nodes 505A and 510A, which in turn contain descendant nodes 515A, 520A and 525A, respectively, which in turn contain descendant nodes 530A, 535A, 540A, 545A and 550A, respectively.

FIGS. 5B-5C illustrate examples of context trees for example documents in accordance with various embodiments of the disclosure. With respect to at least FIGS. 5B-5C, references to context paths and context trees are made below, with these terms being defined as follows:
Context Path: One node in a context tree.
Context Tree: The complete set of all paths in a set of documents.

FIG. 5B illustrates an example of the context tree for a “Company” document based on the data from Tables 1 and 3 (above). Referring to FIG. 5B, there is a root context path “Company” 500B, and three descendant context paths 505B, 510B, 515B for “Name”, “Industry” and “Headquarters” values, respectively. For a JSON-based semi-structured database, the data object depicted above in Tables 1 and 3 may be recorded as follows:

TABLE 5
Example of JSON-based Semi-Structured Database Entry for a Company
Data Object

```
{
  “Company”: “Company X”,
  “Industry”: [
      “Semiconductor”,
      “Wireless telecommunications” ],
  “Headquarters” :
      “San Diego, California, USA”
}
```

FIG. 5C illustrates an example of the context tree for a “Bibliography” document based on the data from Tables 2 and 4 (above). Referring to FIG. 5C, there is a root context path “Bibliography” 500C, which has four descendant context paths 505C, 510C, 515C and 520C for “Author”, “Title”, “Journal” and “Date”, respectively. The Author context path 505C further has two additional descendant context paths 525C and 530C for “First Name” and “Last Name”, respectively. Further, the context path “Journal” 515C has four descendant context paths 535C, 540C, 545C and 550C for “Name”, “Issue”, “Chapter” and “Page”, respectively. For an XML-based semi-structured database, the data object depicted above in Tables 2 and 4 that is authored by J. Cox may be recorded as follows:

TABLE 6
Example of XML-based Semi-Structured Database Entry
for a Bibliography Data Object

```
<Bibliography>
      <Author>
            <LastName>Cox</LastName>
            <FirstName>J.</FirstName>
      </Author>
      <Title>Company X races ...</Title>
      <Journal>
            <Name>Network World</Name>
            <Issue>24</Issue>
            <Chapter>8</Chapter>
            <Page>26</Page>
      </Journal>
      <Date>2007</Date>
</Bibliography>
```

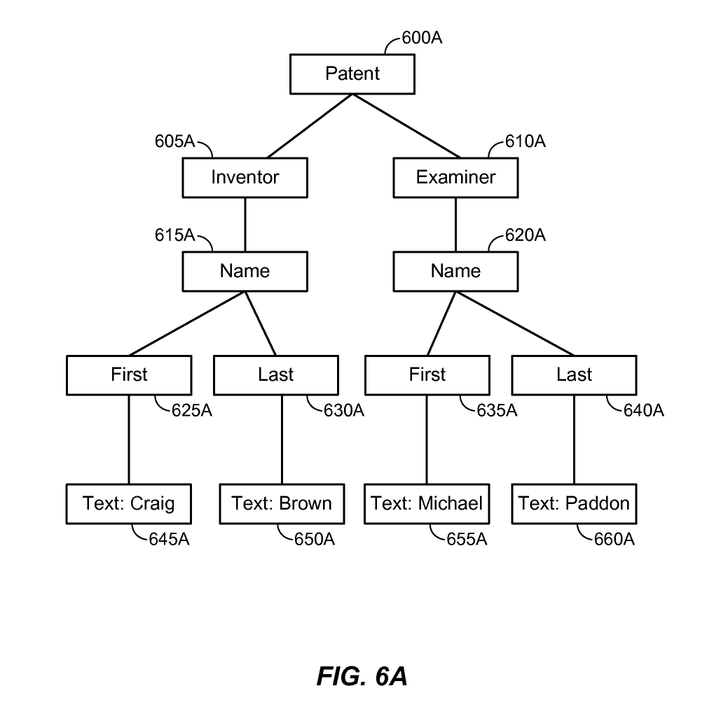

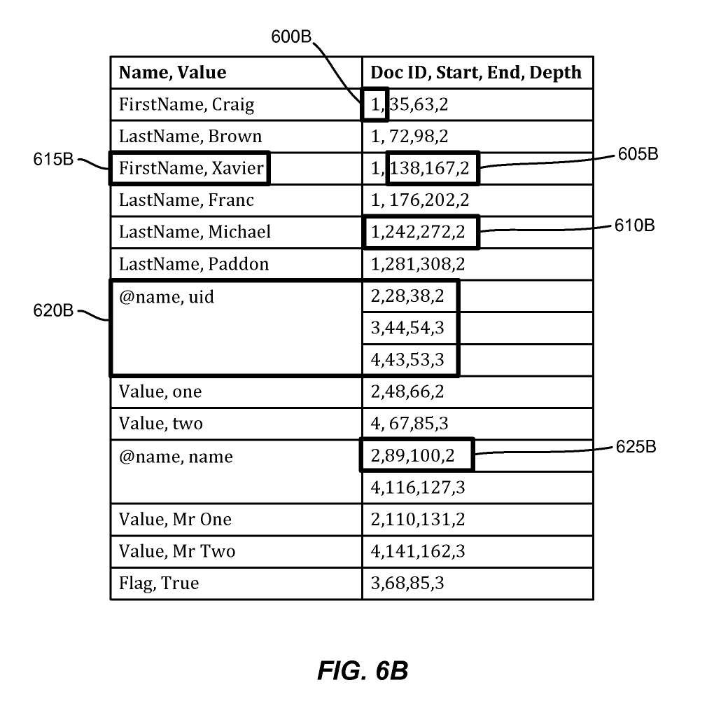

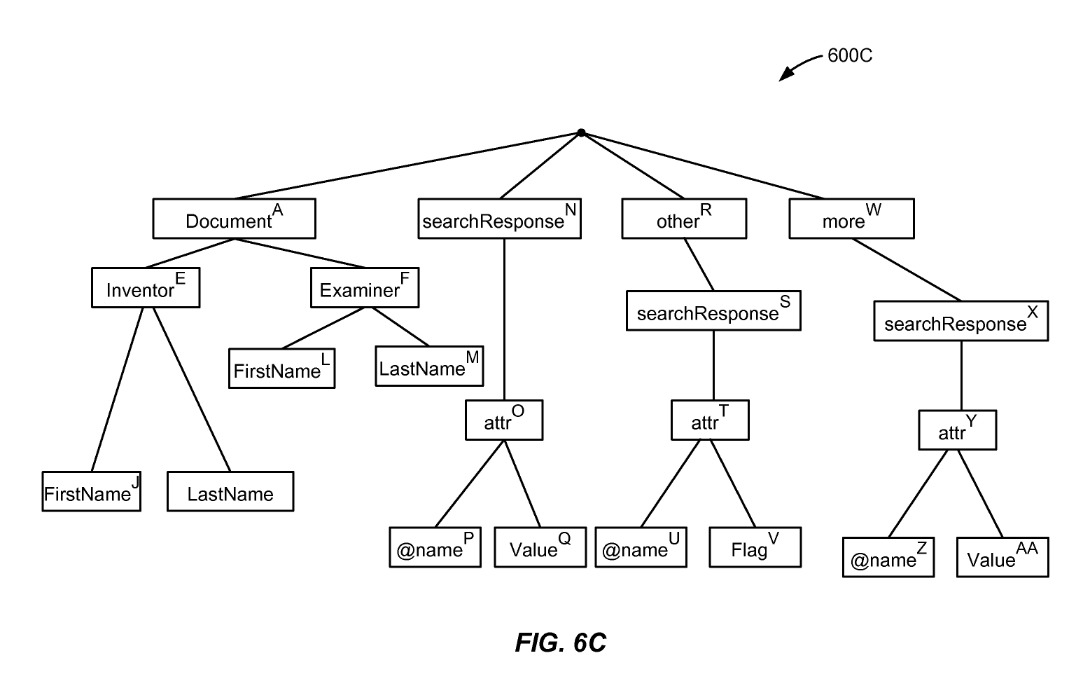

FIG. 6A illustrates an example context tree for a “Patent” document in accordance with an embodiment of the disclosure. In FIG. 6A, the document is a patent information database with a root node “Patent” 600A, which has two descendant nodes 605A and 610A for “Inventor” and “Examiner”, respectively. Each has a descendant node entitled “Name”, 615A and 620A, which in turn each have descendant nodes entitled “First” and “Last”, 625A, 630A, 635A and 640A. Further depicted in FIG. 6A are textual data objects that are stored in the respective nodes 625A-640A. In particular, for an Examiner named “Michael Paddon” and an inventor named “Craig Brown” for a particular patent document, the text “Craig” 645A is stored in a node represented by the context path /Patent/Inventor/Name/First, the text “Brown” 650A is stored in a node represented by the context path /Patent/Inventor/Name/Last, the text “Michael” 655A is stored in a node represented by the context path /Patent/Examiner/Name/First and the text “Paddon” 660A is stored in a node represented by the context path /Patent/Examiner/Name/Last. As will be discussed below in more detail, each context path can be associated with its own index entry in a Context Path Element Index, and each unique value at a particular context path can also have its own index entry in a Context Path Simple Content Index.

To put the document depicted in FIG. 6A into context with respect to XPath queries in an example where the semi-structured database corresponds to an XML database, an XPath query directed to /Patent/Inventor/Name/Last will return each data object at this context path within the tree hierarchy, in this case, “Brown”. In another scenario, the XPath query can implicate multiple nodes. For example, an XPath query directed to //Name/Last maps to both the context path /Patent/Inventor/Name/Last and the context path /Patent/Examiner/Name/Last, so this query would return each data object at any qualifying location of the tree hierarchy, in this case, both “Brown” and “Paddon”.

The document structure of a particular document in a semi-structured database can be indexed in accordance with a flat-indexing protocol or a label-path protocol. For example, in the flat-indexing protocol (sometimes referred to as a “node indexing” protocol) for an XML database, each node is indexed with a document identifier at which the node is located, a start-point and an end-point that identifies the range of the node, and a depth that indicates the node's depth in the tree hierarchy of the document (e.g., in FIG. 6A, the root node “Patent” 600A (or root context path) has depth=0, the “Inventor” and “Examiner” context paths 605A and 610A have depth=1, and so on). The range of any parent node envelops or overlaps with the range(s) of each of the parent node's respective descendant nodes. Accordingly, assuming that the document identifier is 40, the root node “Patent” 600A document depicted in FIG. 6A can be indexed as follows:

TABLE 7
Example of XML-based Tree Hierarchy Shown in FIG. 6A

```
<Patent>¹
      <Inventor>²
            <Name>³
                  <First>⁴ Craig</First>⁵
                  <Last>⁶ Brown</Last>⁷
            </Name>⁸
      </Inventor>⁹
      <Examiner>¹⁰
            <Name>¹¹
                  <First>¹² Michael</First>¹³
                  <Last>¹⁴ Paddon</Last>¹⁵
            </Name>¹⁶
      </Examiner>¹⁷
</Patent>¹⁸
```

whereby each number represents a location of the document structure that can be used to define the respective node range, as shown in Table 8 as follows:

TABLE 8
Example of Flat-Indexing of Nodes of FIG. 6A Based on Table 7

| Name, Value | Docid, Start, End, Depth |
|---|---|
| Inventor | (40, 2, 9, 1) |
| Name | (40, 3, 8, 2), |
| | (40, 11, 16, 2) |
| Last, Brown | (40, 6, 7, 3) |
| Last, Paddon | (40, 14, 15, 3) |

Accordingly, the “Inventor” context path 605A of FIG. 6A is part of document 40, starts at location 2 and ends at location 9 as shown in Table 7, and has a depth of 1 in the tree hierarchy depicted in FIG. 6A, such that the “Inventor” context path 605A is indexed as (40,2,9,1) in Table 8. The “Name” context paths 615A and 620A of FIG. 6A are part of document 40, start at locations 3 and 11, respectively, and end at locations 8 and 16, respectively, as shown in Table 7, and have a depth of 2 in the tree hierarchy depicted in FIG. 6A, such that the “Name” context paths 615A and 620A are indexed as (40,3,8,2) and (40,11,16,2) in Table 8.

When a node stores a value, the value itself can have its own index. Accordingly, the value of “Brown” 650A as shown in FIG. 6A is part of document 40, start at location 6 and ends at location 7 as shown in Table 7, and has a depth of 3 (i.e., the depth of the node that stores the associated value of “Brown”) in the tree hierarchy depicted in FIG. 6A, such that the “Brown” value 650A is indexed as (40,6,7,3) in Table 8. The value of “Paddon” 660A as shown in FIG. 6A is part of document 40, start at location 14 and ends at location 15 as shown in Table 7, and has a depth of 3 (i.e., the depth of the node that stores the associated value of “Paddon”) in the tree hierarchy depicted in FIG. 6A, such that the “Paddon” value 660A is indexed as (40,14,15,3) in Table 8.

The flat-indexing protocol uses a brute-force approach to resolve paths. In an XML-specific example, an XPath query for /Patent/Inventor/Name/Last would require separate searches to each node in the address (i.e., “Patent”, “Inventor”, “Name” and “Last”), with the results of each query being joined with the results of each other query, as follows:

TABLE 9
Example of XPath Query for a Flat-Indexed Database

```
joinChild(
      joinChild(
            joinChild(
                  lookup(Patent),
                  lookup(Inventor)),
            lookup(Name)),
      lookup(Last))
```

Label-path indexing is described in a publication by Goldman et al. entitled “DataGuides: Enabling Query Formulation and Optimization in Semistructured Databases”. Generally, label-path indexing is an alternative to flat-indexing, whereby the path to the target node is indexed in place of the node identifier of the flat-indexing protocol, as follows:

TABLE 10
Example of XML-based Tree Hierarchy Shown in FIG. 6A

```
<Patent>_{A}¹
      <Inventor>_{B}²
            <Name>_{C}³
                  <First>_{D}⁴Craig</First>⁵
                  <Last>_{E}⁶Brown</Last>⁷
            </Name>⁸
      </Inventor>⁹
      <Examiner>_{F}¹⁰
            <Name>_{G}¹¹
                  <First>_{H}¹²Michael</First>¹³
                  <Last>_{I}¹⁴Paddon</Last>¹⁵
            </Name>¹⁶
      </Examiner>¹⁷
</Patent>¹⁸
```

whereby each number represents a location of the document structure that can be used to defined the respective node range, and each letter label (A through I) identifies a context path to a particular node or value, as shown in Table 11 as follows:

TABLE 11
Example of Label-Path Indexing of Nodes of FIG. 6A Based on Table 10

| Context Path, Node or Value | Docid, Start, End, Depth |
|---|---|
| B (/Patent/Inventor) | (40, 2, 9, 1) |
| C (/Patent/Inventor/Name) | (40, 3, 8, 2) |
| E (/Patent/Inventor/Name/Last), Brown | (40, 6, 7, 3) |
| H(/Patent/Examiner/Name/First), Michael | (40, 12, 13, 3) |

Accordingly, with respect to Tables 10-11, the “Inventor” node 605A of FIG. 6A at the context path /Patent/Inventor (or context path B) is part of document 40, starts at location 2 and ends at location 9 as shown in Table 10, and has a depth of 1 in the tree hierarchy depicted in FIG. 6A, such that the “Inventor” context path 605A is indexed as (40,2,9,1) in Table 11. The “Name” context path 615A of FIG. 6A at the context path /Patent/Inventor/Name (or context path C) is part of document 40, starts at location 3 and ends at location 8 as shown in Table 10, and has a depth of 2 in the tree hierarchy depicted in FIG. 6A, such that the “Name” context path 615A is indexed as (40,3,8,2) in Table 11. The “Brown” value 650A of FIG. 6A at the context path /Patent/Inventor/Name/Last (or context path E) is part of document 40, starts at location 6 and ends at location 7 as shown in Table 10, and has a depth of 3 (i.e., the depth of the node that stores the “Brown” value 650A) in the tree hierarchy depicted in FIG. 6A, such that the “Brown” value 650A is indexed as (40,6,7,3) in Table 11. The “Michael” value 655A of FIG. 6A at the context path /Patent/Examiner/Name/First (or context path H) is part of document 40, starts at location 12 and ends at location 13 as shown in Table 10, and has a depth of 3 (i.e., the depth of the node that stores the “Michael” value 655A) in the tree hierarchy depicted in FIG. 6A, such that the “Michael” value 655A is indexed as (40,12,13,3) in Table 11.

More detailed XML descriptions will now be provided. At the outset, certain XML terminology is defined as follows:
Byte Offset: Byte count from the start of a file. In certain embodiments of this disclosure, it is assumed that one character is equal to one byte, but it will be appreciated by one of ordinary skill in the art this is simply for convenience of explanation and that multi-byte characters such as those used in foreign languages could also be handled in other embodiments of this disclosure.
Context ID: A unique ID for a context path. In certain embodiments of this disclosure, the Context ID is indicated via a single capital letter.
Node ID: Start byte offset, end byte offset, and depth uniquely identifying a node within a document.
Document ID/Doc ID: Identifier uniquely identifying an XML document index.
Context Path Element Index: Index where the index key contains a Context ID. Used for elements that contain both simple and complex content, where simple content means the element contains text only and complex content means elements contain other elements or a mixture or text and elements. The index value contains a Doc ID/Node ID pair.
Context Path Simple Content Index: Index where the index key contains a Context ID and a value. The index value contains a Doc ID/Node ID pair.
Flat Element Index: Index where the index key contains a node name. Used for elements that contain both simple and complex content. The index value contains a Doc ID/Node ID pair.
Flat Simple Context Index: Index where the index key contains a node name and a value. The index value contains a Doc ID/Node ID pair.
Path Instance: The route from the top of a document down to a specific node within the document.
Posting: Doc ID/Node ID tuple uniquely identifying a node within a database.
XML Document: A single well-formed XML document.

In Table 9 with respect to the flat-indexed protocol, it will be appreciated that the XPath query directed to /Patent/Inventor/Name/Last required four separate lookups for each of the nodes “Patent”, “Inventor”, “Name” and “Last”, along with three joins on the respective lookup results. By contrast, a similar XPath query directed to /Patent/Inventor/Name/Last using the label-path indexing depicted in Tables 10-11 would have a compiled query of lookup(E) based on the path /Patent/Inventor/Name/Last being defined as path “E”.

Generally, the label-path indexing protocol is more efficient for databases with a relatively low number of context paths for a given node name (e.g., less than a threshold such as 100), with the flat-indexing protocol overtaking the label-path indexing protocol in terms of query execution time as the number of context paths increases.

A number of different example XML document structures are depicted below in Table 12 including start and end byte offsets:

TABLE 12
XML Document Examples with Start and End Byte Offsets

```
Document 1
<Document>_{A}⁰
  <Inventor>_{E}¹⁶
    <FirstName>_{J}³⁵Craig</FirstName>⁶³
    <LastName>_{K}⁷²Brown</LastName>⁹⁸
  </Inventor>¹¹⁴
  <Inventor>_{E}¹¹⁹
    <FirstName>_{J}¹³⁸Xavier</FirstName>¹⁶⁷
    <LastName>_{K}¹⁷⁶Franc</LastName>²⁰²
  </Inventor>²¹⁸
  <Examiner>_{F}²²³
    <FirstName>_{L}²⁴²Michael</FirstName>²⁷²
    <LastName>_{M}²⁸¹Paddon</LastName>³⁰⁸
  </Examiner>³²⁴
</Document>³³⁶
Document 2
<searchResponse>_{N}⁰
  <attr ²⁸name_{P} =”uid”³⁸>_{O}²²
    <Value>_{Q}⁴⁸one</Value>⁶⁶
  </attr>⁷⁸
  <attr⁸⁹name_{P}=”name”¹⁰⁰>_{O}¹¹⁰
    <Value>_{Q}¹¹⁰Mr One</Value>¹³¹
  </attr>¹⁴³
</searchResponse>¹⁶¹
Document 3
<other>_{R}⁰
  <searchResponse>_{S}¹³
    <attr⁴⁴name_{U}=”uid”54>_{T}³⁸
      <Flag>_{V}⁶⁸True</Flag>⁸⁵
    </attr>¹⁰¹
  </searchResponse>¹²³
</other>¹³²
Document 4
<more>_{W}⁰
  <searchResponse>_{X}¹²
    <attr ⁴³name_{Z}=”uid” ⁵³>_{Y}³⁷
      <Value>_{AA}⁶⁷two</Value>⁸⁵
    </attr>¹⁰¹
    <attr¹¹⁶name_{Z}=”name” ¹²⁷>_{Y}¹¹⁰
      <Value>_{AA}¹⁴¹Mr Two</Value>¹⁶²
    </attr>¹⁷⁸
  </searchResponse>²⁰⁰
</more>²⁰⁸
```

whereby each number represents a location of the document structure that can be used to defined the respective node range, and each letter label identifies a context path to a particular node or value as depicted in FIG. 6C (described below in more detail).

Next, a flat simple content index for the documents depicted in Table 12 is as follows:

TABLE 13
Flat Simple Content Index

| Name, Value | Doc ID, Start, End, Depth |
|---|---|
| FirstName, Craig | 1, 35, 63, 2 |
| LastName, Brown | 1, 72, 98, 2 |
| FirstName, Xavier | 1, 138, 167, 2 |
| LastName, Franc | 1, 176, 202, 2 |
| FirstName, Michael | 1, 242, 272, 2 |
| LastName, Paddon | 1, 281, 308, 2 |
| @name, uid | 2, 28, 38, 2 |
| | 3, 44, 54, 3 |
| | 4, 43, 53, 3 |
| Value, one | 2, 48, 66, 2 |
| Value, two | 4, 67, 85, 3 |
| @name, name | 2, 89, 100, 2 |
| | 4, 116, 127, 3 |
| Value, Mr One | 2, 110, 131, 2 |
| Value, Mr Two | 4, 141, 162, 3 |
| Flag, True | 3, 68, 85, 3 |

Next, a flat element index for the documents depicted in Table 12 is as follows,

TABLE 14
Flat Element Index

| Name | Doc ID, Start, End, Depth |
|---|---|
| document | 1, 0, 336, 0 |
| Inventor | 1, 16, 114, 1 |
| | 1, 119, 218, 1 |
| FirstName | 1, 35, 63, 2 |
| | 1, 138, 167, 2 |
| | 1, 242, 272, 2 |
| LastName | 1, 72, 98, 2 |
| | 1, 176, 202, 2 |
| | 1, 281, 308, 2 |
| Examiner | 1, 223, 324, 1 |
| searchResponse | 2, 0, 161, 0 |
| | 3, 13, 123, 1 |
| | 4, 12, 200, 1 |
| other | 3, 0, 132, 0 |
| more | 4, 0, 208, 0 |
| @name | 2, 28, 38, 2 |
| | 3, 44, 54, 3 |
| | 4, 43, 53, 3 |
| | 2, 89, 100, 2 |
| | 4, 116, 127, 3 |
| Value | 2, 48, 66, 2 |
| | 2, 110, 131, 2 |
| | 4, 67, 85, 3 |
| | 4, 141, 162, 3 |
| Flag | 3, 68, 85, 3 |

FIG. 6B illustrates an annotated version of Table 13, including examples of a document identifier 600B (e.g., “1” for document 1 of Table 12), a node identifier 605B (e.g., 138,167,2, to denote the start byte, end byte and depth of a particular node, respectively), an index value 610B (e.g., a combination of document identifier, and index value), an index key 615B (e.g., “FirstName:Xavier”), an index entry 620B (e.g., a combination of index key and each associated index value) and a posting 625B (e.g., one of a plurality of document identifier and node identifier combinations for a particular index entry).

FIG. 6C illustrates a context tree 600C with labeled context paths based on the documents depicted above in Table 12, and further based on the context tree simple content index depicted below in Table 15 and the context tree element index depicted below in Table 16:

TABLE 15
Context Tree Simple Content Index

| Context ID, Value | Doc ID, Start, End, Depth |
|---|---|
| J, Craig | 1, 35, 63, 2 |
| K, Brown | 1, 72, 98, 2 |
| J, Xavier | 1, 138, 167, 2 |
| K, Franc | 1, 176, 202, 2 |
| L, Michael | 1, 242, 272, 2 |
| M, Paddon | 1, 281, 308, 2 |
| P, uid | 2, 28, 38, 2 |
| U, uid | 3, 44, 54, 3 |
| Z, uid | 4, 43, 53, 3 |
| Q, one | 2, 48, 66, 2 |
| AA, two | 4, 67, 85, 3 |
| P, name | 2, 89, 100, 2 |
| Z, name | 4, 116, 127, 3 |
| Q, Mr One | 2, 110, 131, 2 |
| AA, Mr Two | 4, 141, 162, 3 |
| V, True | 3, 68, 85, 3 |

TABLE 16
Context Tree Element Index

| Name | Doc ID, Start, End, Depth |
|---|---|
| A | 1, 0, 336, 0 |
| E | 1, 16, 114, 1 |
| | 1, 119, 218, 1 |
| J | 1, 35, 63, 2 |
| | 1, 138, 167, 2 |
| L | 1, 242, 272, 2 |
| K | 1, 72, 98, 2 |
| | 1, 176, 202, 2 |
| M | 1, 281, 308, 2 |
| F | 1, 223, 324, 1 |
| N | 2, 0, 161, 0 |
| S | 3, 13, 123, 1 |
| X | 4, 12, 200, 1 |
| R | 3, 0, 132, 0 |
| W | 4, 0, 208, 0 |
| P | 2, 28, 38, 2 |
| | 2, 89, 100, 2 |
| U | 3, 44, 54, 3 |
| Z | 4, 43, 53, 3 |
| | 4, 116, 127, 3 |
| O | 2, 48, 66, 2 |
| | 2, 110, 131, 2 |
| AA | 4, 67, 85, 3 |
| | 4, 141, 162, 3 |
| V | 3, 68, 85, 3 |

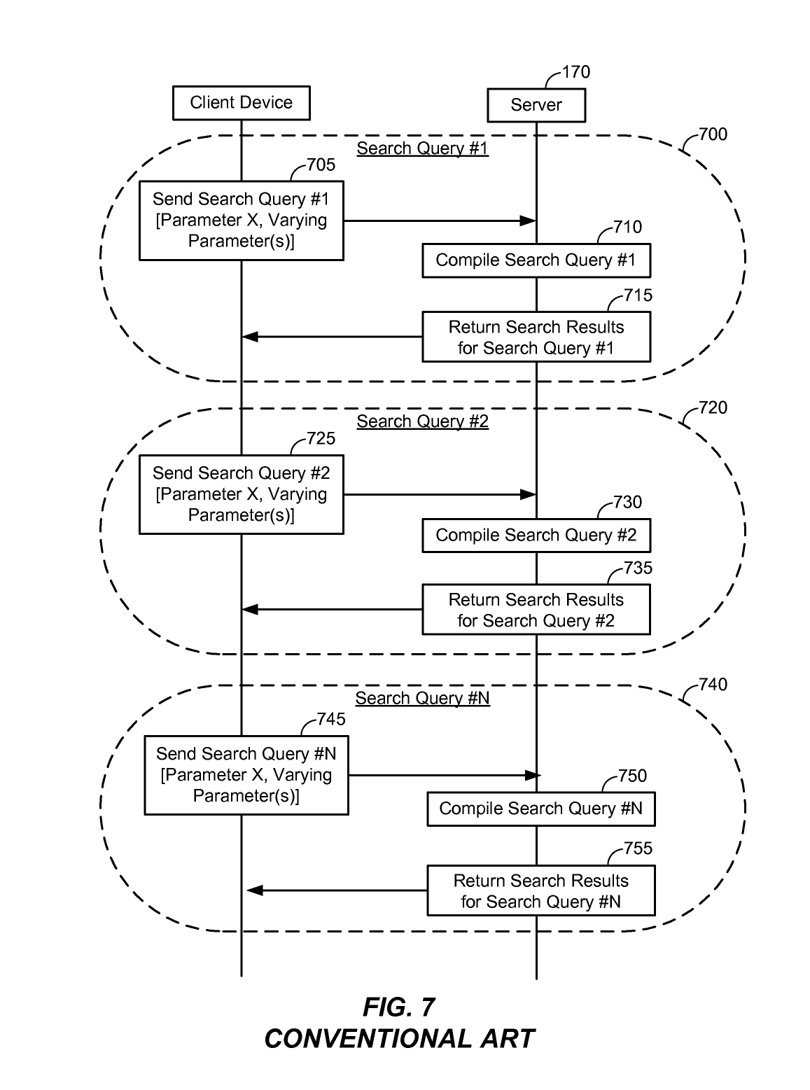

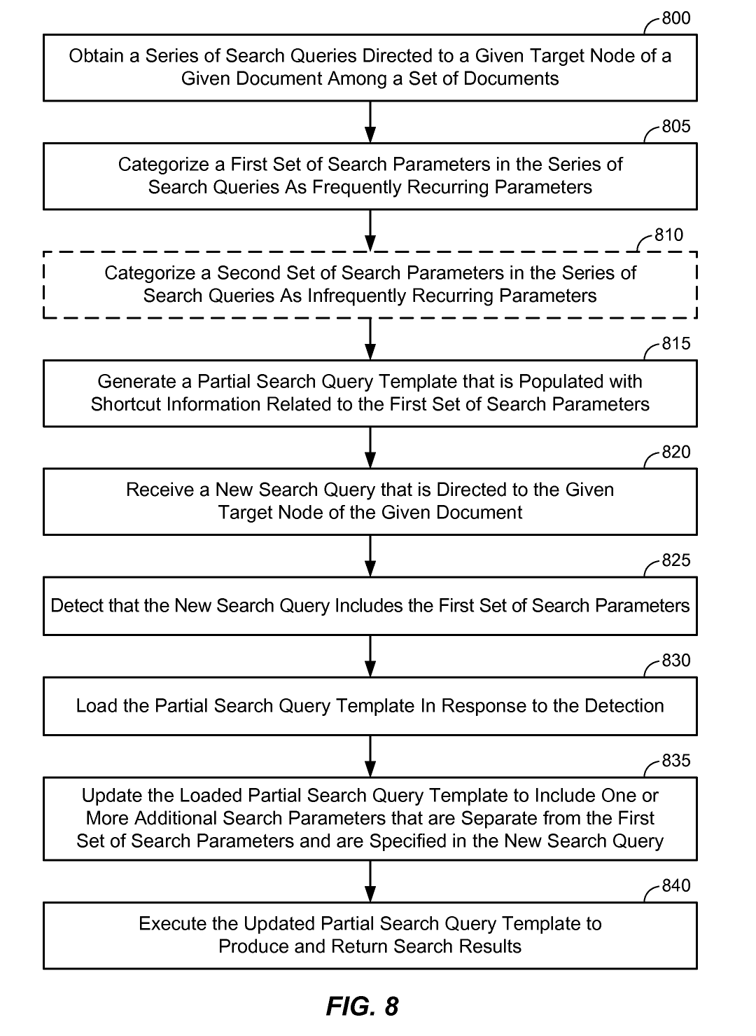

FIG. 7 illustrates a conventional process by which search queries are executed in a semi-structured database. Referring to FIG. 7, block sequence 700 depicts execution of a first search query, whereby a given client device sends the first search query to the semi-structured database server 170, in block 705, the semi-structured database server 170 compiles each search parameter in the first search query to obtain search results, in block 710, and the semi-structured database server 170 returns any search results for the first search query back to the given client device, in block 715. In an example, compiling the search query at block 710 can include a number of operations, such as joining search results returned for different search parameters. In an XML example, the first search query may be received at the semi-structured database server 170 at block 705 as an XPath query configured as “//path/to/node[criteria1=valueX && criteria2=valueZ_1”, which compiles as follows at block 710:

TABLE 17
Compiled XML XPath Search Query Example #1

```
{
joinContainment(
      joinContainment (
            lookup(//path/to/node)
            criteria1=valueX),
      criteria2=valueZ_1)
}
```

As will be appreciated, the compiled XPath search query depicted in Table 17 requires lookups for both criteria1=valueX (or “Parameter X”) and also for criteria2=valueZ_1.

Referring to FIG. 7, block sequence 720 depicts execution of a second search query, whereby the same or different client device sends the second search query to the semi-structured database server 170, in block 725, the semi-structured database server 170 compiles each search parameter in the second search query to obtain search results, in block 730, and the semi-structured database server 170 then returns any search results for the second search query back to the given client device, in block 735. In an example, compiling the search query at block 730 can include a number of operations, such as joining search results returned for different search parameters. In an XML example, the second search query may be received at the semi-structured database server 170 at block 725 as an XPath query configured as “//path/to/node[criteria1=valueX && criteria2=valueZ_2”, which compiles as follows at block 730:

TABLE 18
Compiled XML XPath Search Query Example #2

```
{
joinContainment(
      joinContainment (
            lookup(//path/to/node)
            criteria1=valueX),
      criteria2=valueZ_2)
}
```

As will be appreciated, the compiled XPath search query depicted in Table 18 requires lookups for both criteria1=valueX (or “Parameter X”) and also for criteria2=valueZ_2. As will be appreciated, Parameter X is a recurring parameter that was also part of the first compiled XPath search query depicted in Table 17 (above), while criteria2 has a different (or varying) value, as valueZ_2 is not the same as valueZ_1.

Referring to FIG. 7, block sequence 740 depicts execution of an Nth search query, whereby the same or different client device sends the Nth search query to the semi-structured database server 170, in block 745, the semi-structured database server 170 compiles each search parameter in the Nth search query to obtain search results, in block 750, and the semi-structured database server 170 then returns any search results for the Nth search query back to the given client device, in block 755. In an example, compiling the search query at block 750 can include a number of operations, such as joining search results returned for different search parameters. In an XML example, the Nth search query may be received at the semi-structured database server 170 at block 745 as an XPath query configured as “//path/to/node[criteria1=valueX && criteria2=valueZ_N”, which compiles as follows at block 750:

TABLE 19
Compiled XML XPath Search Query Example #3

```
{
joinContainment(
      joinContainment (
            lookup(//path/to/node)
            criteria1=valueX),
      criteria2=valueZ_N)
}
```

As will be appreciated, the compiled XPath search query depicted in Table 19 requires lookups for both criteria1=valueX (or “Parameter X”) and also for criteria2=valueZ_N. As will be appreciated, Parameter X is a recurring parameter that was also part of the first and second compiled XPath search query depicted in Tables 17 and 18 (above), while criteria2 has a different (or varying) value, as valueZ_N is not the same as valueZ_1 or valueZ_2.

As will be appreciated, the efficiency of the search query executions depicted in FIG. 7 include a recurring (or redundant) component with respect to the repeated lookups conducted for Parameter X. Embodiments of the disclosure are directed to selectively generating a partial search template that pre-populates shortcut information (e.g., lookup results from prior search query executions) for certain parameters that are recognized as recurring parameters.

FIG. 8 illustrates a process of generating a partial search query template for a semi-structured database in accordance with an embodiment of the disclosure. Referring to FIG. 8, the semi-structured database server 170 obtains (and executes) a series of search queries directed to a given target node of a given document among a set of documents in the semi-structured database, in block 800. The semi-structured database server 170 categorizes a first set of search parameters in the series of search queries as frequently recurring parameters, in block 805. In an example, the semi-structured database server 170 may also categorize a second set of search parameters in the series of search queries as infrequently recurring parameters, in block 810. In an example, the operation of block 810 is considered may be performed in a selective manner because the semi-structured database server 170 may be configured to interpret any search parameter that is not yet part of the first set of search parameters as being an infrequently recurring parameter as a default condition.

Referring to FIG. 8, the semi-structured database server 170 generates a partial search query template that is populated with shortcut information related to the first set of search parameters, in block 815. The shortcut information may include any type of information that speeds up the search query execution time in association with the first set of search parameters. For example, in an XML example, the shortcut information can include join results of a component of an XPath query so that join operation(s) for the first set of search parameters can be skipped at run-time. In an example, the categorizing of blocks 805 and 810 and the partial search query template generating of block 815 can be performed manually by an operator of the semi-structured database, or alternatively can be implemented automatically based upon an analysis of search query statistics.

After the partial search query template is generated at block 815, the semi-structured database server 170 receives a new search query that is directed to the given target node of the given document among the set of documents and includes the first set of search parameters, in block 820. At block 825, the semi-structured database server 170 detects or recognizes that the new search query includes the first set of search parameters, and the semi-structured database server 170 loads the partial search query template from block 815 in response to the detection, in block 830. Upon loading the partial search query template, the semi-structured database server 170 updates the partial search query template to include one or more search parameters that are separate from the first set of search parameters and are specified in the new search query, in block 835. The semi-structured database server 170 then executes the updated partial search query template to produce search results, which are returned to a requesting client device that initiated the new search query, in block 840.

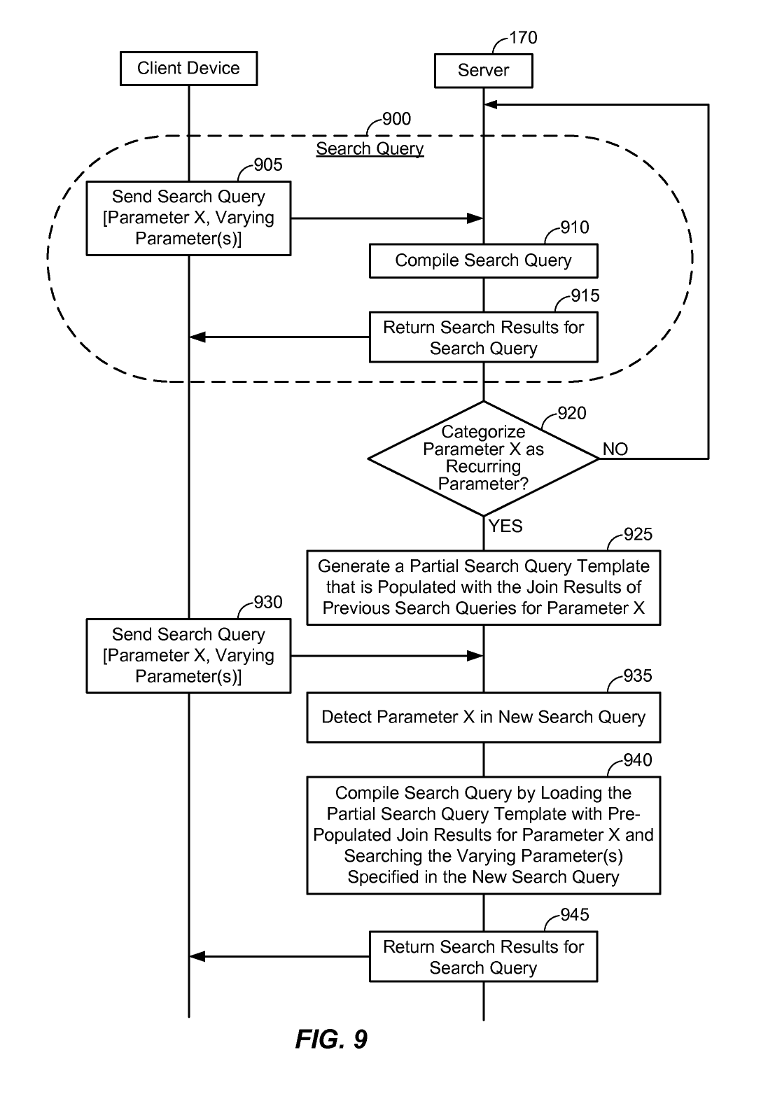

FIG. 9 illustrates an example implementation of the process of FIG. 8 in accordance with an embodiment of the disclosure. Referring to FIG. 9, block sequence 900 depicts execution of a search query, whereby a given client device sends the search query to the semi-structured database server 170, in block 905, the semi-structured database server 170 compiles each search parameter in the search query to obtain search results, in block 910, and the semi-structured database server 170 then returns any search results for the search query back to the given client device, in block 915. At block 920, the semi-structured database server 170 determines whether any parameters of the search query warrant categorization as a frequently recurring parameter, in block 920. If not, the process returns to block 900 and the semi-structured database server 170 executes another search query that arrives from the given client device or a different client device. However, if the semi-structured database server 170 determines to categorize one or more parameters of the search query as frequently recurring parameters, the process advances to block 925. As will be appreciated, the repeated execution of search queries in block 900 corresponds to block 800 of FIG. 8, while the decision block of block 920 corresponds to blocks 805-810 of FIG. 8. In an XML example, the search queries may be received over time via execution of block 900 are compiled as shown above in Tables 17-19, with the semi-structured database server 170 determining to categorize Parameter X as a frequently recurring parameter at block 920. As noted above with respect to FIG. 8, the categorization in block 920 can be implemented according to various criteria that indicates a popularity of a certain criterion or group of criteria. In one example implementation of block 920, a threshold can be defined, whereby in response to meeting the threshold, for example, a number of search queries to a particular target node containing a particular search parameter exceeding the threshold within a given period of time, the particular search parameter is auto-categorized as a frequently recurring parameter. Alternatively, search query heuristics (or historical search information) may be used to identify a particular search parameter for a node as popular and used to change a status of the particular search parameter for that node to “frequently recurring”. In another example, user input or indication may be used to determine that a node is frequently recurring. For example, an operator of the semi-structured database server 170 may provide various inputs that provide an indication that certain nodes are “frequently recurring.” In various implementations, a combination of the above criteria, in combination with other popularity indicators, may provide for a determination that a parameter is recurring.

At block 925, after determining to categorize the one or more parameters of the search query as frequently recurring parameters, the semi-structured database server 170 generates a partial search query template that is populated with shortcut information related to the one or more parameters (e.g., similar to block 815 of FIG. 8). In the XML example depicted in Tables 17-19 above whereby criteria1 (or Parameter X) is deemed to be a frequently recurring parameter, the partial search query template may be configured as follows:

TABLE 20
Compiled XML Partial Search Query Template Example

```
{
joinContainment (
      [*pre-Calculated Search Results for Parameter X],
      criteria2=[*InsertAtRunTime])
}
```

whereby the parameter [*Pre-Calculated Nodes for Parameter X] corresponds to the search results (e.g., a list of qualifying nodes, join results, etc.) for Parameter X from execution of any of the compiled search queries depicted in Tables 17-19, and whereby any infrequently recurring parameters (or varying parameters) are permitted to be inserted into the partial search query template during execution after an actual search query is obtained. As will be appreciated, the partial search query template depicted in Table 20 omits a join operation by virtue of incorporating the previous join results for the Parameter X component of one or more previous search queries, such that execution of the partial search query template depicted in Table 20 (once updated to permit insertion of criteria2 and any other parameters specified in a future search query) can be performed more quickly relative to a comparable search query that required a new lookup operation for Parameter X.

After the partial search query template is generated at block 925, the semi-structured database server 170 receives a new search query that is directed to the given target node of the given document among the set of documents and includes the first set of search parameters, in block 930 (e.g., similar to block 820 of FIG. 8). At block 935, the semi-structured database server 170 detects or recognizes that the new search query includes the first set of search parameters (e.g., Parameter X), and the semi-structured database server 170 loads the partial search query template from block 925 in response to the detection, in block 940 (e.g., as in blocks 825-830 of FIG. 8). In an example, the partial search query template may be stored in memory with one or more other partial search query templates, with each search query template being stored in association with a key that is based on its respective first set of search parameters. When the new search query arrives in block 925, the semi-structured database server 170 may compare the search parameters to the stored partial search query templates in block 935 to determine a best match (e.g., if the new search queries includes one search parameter in common with a first partial search query template and four search parameters in common with a second partial search query template, the second partial search query template may used in block 940). Upon loading the partial search query template, the semi-structured database server 170 updates the partial search query template to include one or more search parameters that are separate from the first set of search parameters and are specified in the new search query, in block 940. The semi-structured database server then executes the updated partial search query template to produce search results, which are returned to a requesting client device that initiated the new search query, in block 945 (e.g., similar to block 840 of FIG. 8).

With respect to block 940 of FIG. 9, the run-time compiled search queries based on the partial search query template for the XPaths depicted in Tables 17-19 (above) can be configured as follows:

TABLE 21
Compiled XML XPath Search Query at Block 940 of FIG. 9 Based on
Search Query Template Using Example #1 from Table 17

```
{
joinContainment(
      [*Pre-Calculated Search Results for Parameter X],
      criteria2=valueZ_1)
}
```

TABLE 22
Compiled XML XPath Search Query at Block 940 of FIG. 9 Based on
Search Query Template Using Example #2 from Table 18

```
{
joinContainment(
      [*Pre-Calculated Search Results for Parameter X],
      criteria2=valueZ_2)
}
```

TABLE 23
Compiled XML XPath Search Query at Block 940 of FIG. 9 Based on
Search Query Template Using Example #3 from Table 19

```
{
joinContainment(
      [*Pre-Calculated Search Results for Parameter X],
      criteria2=valueZ_3)
}
```

In the embodiments of FIGS. 8-9, the partial search query template may be cached in a cache memory (e.g., RAM, etc.) of the semi-structured database server 170 in at least one example implementation. The cache memory may be a portion of the memory retained at the semi-structured database server 170, such as the logic configured to store information 315 of FIG. 3, the volatile memory 402 and the disk drive 403 of FIG. 4, etc. Caching the partial search query template can reduce the loading times associated with block 830 of FIG. 8 and/or block 940 of FIG. 9. Further, the partial search query template does not impact the underlying indexing of the nodes or search results which are pre-loaded into the partial search query template. For example, the partial search query template of block 925 in the XML examples shown above between Tables 21-23 may pre-load Nodes Y and Z as previous search results for Parameter X. If Nodes Y and X are indexed via a flat-indexed protocol for example, the pre-loading of Nodes Y and X into the partial search query template does not function to transition the index-type of Nodes Y and X (e.g., Nodes Y and X would remain as flat-indexed as opposed to being transitioned to a label-path index, etc.).

In a further example, multiple partial search query templates can be generated for different nodes and/or different frequently recurring parameters in other embodiments of the disclosure, such that the processes of FIGS. 8 and 9 can be executed as different instances during operation of the semi-structured database.

In yet another example, the partial search query templates generated in the embodiments of FIGS. 8 and 9 can be selectively pruned based on a variety of factors, such as lack of use, reduced memory availability at the semi-structured database server 170 (e.g., in the cache memory, in main memory, etc.) or any combination thereof. For example, the semi-structured database server 170 may identify that some or all of the first set of search parameters for a particular node no longer qualify as frequently recurring parameters (e.g., based on an operator's manual detection, based on a threshold number of queries to the target node omitting the first set of search parameters, etc.). In this case, the semi-structured database server 170 may re-categorize search parameter(s) as infrequently recurring parameters, which can result in the re-categorized search parameter(s) having their shortcut information removed from a corresponding partial search query template or can result in deletion of the corresponding partial search query template in its entirety if each of the first set of search parameters is re-categorized in this manner. Further, a low-memory condition at the semi-structured database server 170 (e.g., in the cache memory, in the main memory, etc.) can trigger deletion of all or part of one or more of the partial search query templates so as to free up memory at the semi-structured database server 170. In this case, some or all of one or more partial search query templates may be deleted even if the corresponding search parameters associated with the deleted shortcut information is still considered to be frequently recurring. In a further example, a combination of memory availability and recurrence frequency can be used to selectively delete some or all of the partial search query templates. For example, the semi-structured database server 170 can detect a low-memory condition and can then attempt to identify the least-used partial search query templates and/or the least-used shortcut information among the partial search query templates for selective deletion.

In an XML-specific example implementation of the process of FIGS. 8-9, a common search query that may contain both frequently recurring parameter(s) and infrequently recurring parameter(s), the XPath query “//searchResponse[attr[@name=”uid” and value=“% s”]]“, whereby the % s (or value) changing from query to query while the other parameters generally stay the same. In this example, the context paths (or entries) depicted in FIG. 6C, whereby the XPath query “//searchResponse[attr[@name=”uid” and value=“% s”]]” may initially be broken into the following expression:

```
containing(
  merge(N,S,X),
  containing(
    merge(O,T,Y),
    merge (P=“uid”,U=“uid”,Z=“uid”) and merge(Q=“%s”, AA=“%s”)
  )
)
```

Context paths S, T U from FIG. 6C can be dropped from the expression from the above query because these context paths do not contain a value node, and the other context paths can potentially be merged. Next, two new context paths can be defined and stored in an index in addition to context paths N-AA as depicted in FIG. 6C, above:

AB: //searchResponse[attr[@name=“uid” and value]], and
AC: //searchResponse/attr[@name=“uid”]/value,

from which a common search can be refined to:

containing(AB, AC=“% s”)

A context tree element index and a context tree simple content index for the above-noted XPaths based on the context tree depicted in FIG. 6C are as follows:

TABLE 24
Context Tree Element Index for XPath Query

| Name | Doc ID, Start, End, Depth |
|---|---|
| AB | 2, 0, 161, 0 |
| | 4, 12, 200, 1 |
| AC | 2, 48, 66, 2 |
| | 4, 67, 85, 3 |

TABLE 25
Context Simple Content Index for XPath Query

| Name | Doc ID, Start, End, Depth |
|---|---|
| AC, one | 2, 48, 66, 2 |
| AC, two | 4, 67, 85, 3 |

With the above two new context path index entries, the original query is processed using the steps listed in table 26, as follows:

TABLE 26

| //searchResponse[attr[@name=“uid” and value=“one”]] | |
|---|---|
| = containing( AB, | AC=“one” ) |
| = containing( ([2:0,161,0],[4:12,200,1]), | [2:48,66,2] ) |

```
= [2:0,161,0]
= <searchResponse>
    <attr name=”uid”>
      <value>one</value>
    </attr>
    <attr name=”name”>
      <value>Mr One</value>
    </attr>
  </searchResponse>
```

As will be appreciated, context paths AB and/or BC correspond to the resultant partial search query template in FIG. 8 or FIG. 9, whereby the more refined containing(AB, AC=“% s”) can be considered an execution result of the context paths AB and AC. In other words, the resultant partial search query templates (context paths AB and AC) are executed in advance to produce the dynamic index (e.g., a partially compiled version of a future query that matches the partial search query templates), whereby the joins that would normally occur during run-time are being pre-computed in the original expression (or template) up-front, which achieves benefits in terms of search time reduction during query-time. The new context paths AB, AC can either be manually specified by the user or can be determined from the queries. Accordingly, in block 825 of FIG. 8 and/or in block 935 of FIG. 9, new queries can be matched against one or more of the partial search query templates (e.g., context paths AB-AC), and the pre-compiled or pre-executed results of any matching partial search query templates (e.g., containing(AB, AC=“% s”)) can then be used to expedite execution of the new queries. Dynamically generated context paths (or partial search query templates) from query analysis may be large in number and subject to pruning based on lack of use, a low-memory condition, or any combination thereof. The context paths AB, AC and the more refined containing (AB, AC=“% s”) may be stored in the cache memory of the semi-structured database server 170 for quicker access at query-time, in an example. Further, the partial search query templates can be used to refer to the context paths themselves, such as context paths AB and AC, or a combination of the context paths plus their associated pre-compiled or pre-executed results (e.g., containing(AB, AC=“% s”)). Accordingly, reference to a partial search query template that is populated with shortcut information related to a set of search parameters may refer to context paths stored in association with their corresponding pre-compiled or pre-executed results.

Further, for each context path (see context paths AB and AC above), every node in the database that matches the context can be identified, with an entry stored in the node index for the dynamic context path/node value pair (otherwise referred to as the partial search query template). The dynamic context path/node value pair (or partial search query template) can be generated using two approaches:

1. When the index is regenerated the XPath queries can be run against elements in all documents and any that hit be also stored in the new dynamic context; or

2. The XPath queries can be run on the existing standard index with any results stored in the dynamic index.

Also, when new documents are placed in the database, the XPath queries can be run against elements in the new documents and any that hit can be stored in the dynamic index.

Structured database tables benefit from explicit user-specified foreign key relationships between tables. This foreign key relationship can be indexed to allow fast joining of data between the tables. By contrast, in semi-structured databases without pre-defined schemes, the generation and maintenance of the references and IDs can be a time consuming and difficult process.

Tables 27A and 27B depict two XML document examples with start and end byte offsets and context paths labeled:

TABLE 27A
Example of XML Document B

```
<document id _{B}¹=”B”>_{A}²
      <citations>_{C}³
A.1  <ref>_{D}⁴C</ref>⁵
A.2  <ref>_{D}⁶D</ref>⁷
      </citations>⁸
</document>⁹
```

TABLE 27B
Example of XML Document A

```
<document id_{B}¹=”A”>_{A}²
      <citations>_{C}³
            <ref>_{D}⁴B</ref>⁵
            <ref>_{D}⁶X</ref>⁷
      </citations>⁸
</document>⁹
```

Tables 27A and 27B illustrate a first document A and a second document B. Below are example indexes based on documents in Tables 27A and 27B:

TABLE 28
Conventional Index

| Path, Value | Docid, Start, End, Depth |
|---|---|
| /document/@id, A | (A, 1, 2, 1) |
| /document/@id, B | (B, 1, 2, 1) |
| /document/citations/ref | (A, 4, 5, 2) |
| | (A, 6, 7, 2) |
| | (B, 4, 5, 2) |
| | (B, 6, 7, 2) |

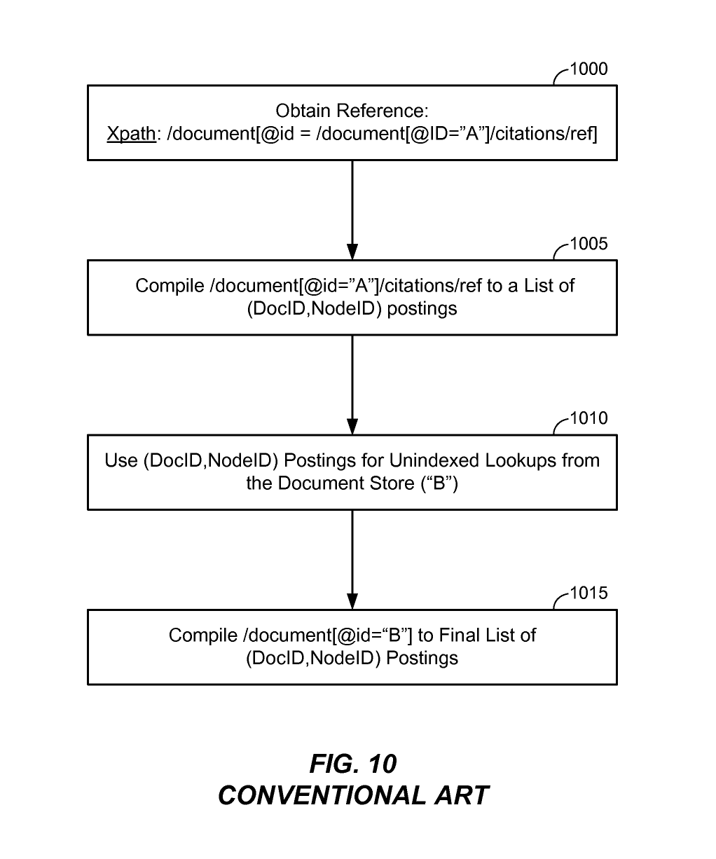

FIG. 10 illustrates a conventional XML-specific process of executing an XPath query without foreign key indexes in a semi-structured database using the documents from Tables 27A-27B. Referring to FIG. 10, the semi-structured database server 170 obtains an XPath query of/document[@id=/document[@id=“A”]/citations/ref], in block 1000, the Right-Hand Side (RHS) of the XPath query (i.e., the portion of the XPath query to the right of the equals sign) or/document[@id=“A”]/citations/ref is then compiled to produce a list of (DocID,NodeID) postings, in block 1005. Then, the (DocID,NodeID) postings are used to perform unindexed lookups from the document store, in this case, the value “B” based on document A having a reference with a value of “B” as shown in Table 27B (e.g., “<ref>_{D}⁴B</ref>⁵”), in block 1010. The “B” value is then input to the Left-Hand Side (LHS) of the XPath query (or/document[@id=“B”] to complete a final list of (DocID,NodeID) postings, in block 1015.

As will be appreciated with respect to FIG. 10, it is difficult for semi-structured databases to recognize when a particular data value is actually a reference (or pointer) to another document altogether. In FIG. 10 in particular, the unindexed lookups from the document store at block 1010 increase the search time and resource consumption associated with execution of the XPath query. Embodiments of the disclosure are thereby directed to building an index that links an initial search query parameter directly to values (or node lists) obtained via a reference so as to reduce or avoid unindexed lookups at run-time.

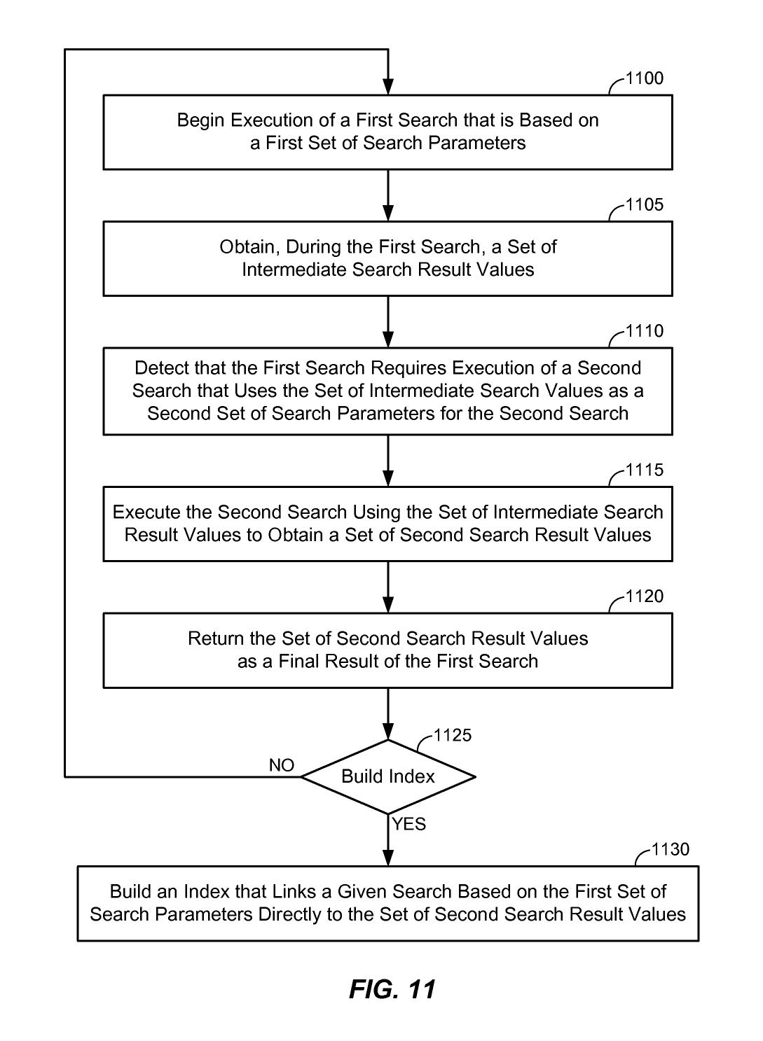

FIG. 11 illustrates a process of building an index for a reference (or pointer) contained in a search query in accordance with an embodiment of the disclosure. At block 1100, the semi-structured database server 170 begins execution of a first search that is based on a first set of search parameters. During the first search, the semi-structured database server 170 obtains a set of intermediate search result values, in block 1105. The semi-structured database server 170 detects that the first search requires execution of a second search that uses the set of intermediate search result values as a second set of search parameters for the second search, in block 1110. In other words, the set of intermediate search values from block 1105 are references (e.g., links or pointers) that redirect to a different portion of the same document or a different document altogether.

The semi-structured database server 170 thereby executes the second search using the set of intermediate search result values to obtain a set of second search result values, in block 1115, and the set of second search result values (e.g., in place of or in addition to the set of intermediate search result values from block 1105) are returned as part of a final result of the first search, in block 1120. While not illustrated explicitly in FIG. 11, it is possible that the set of intermediate search result values point to one or more other sets of intermediate search result values (e.g., a pointer to a pointer to a pointer, etc.), in which case blocks 1105-1115 can repeat until final (non-pointer or non-reference) search result values are obtained.

At block 1125, the semi-structured database server 170 evaluates one or more conditions associated with the first search to determine whether to build an index for the first set of search parameters. These conditions may include, in any combination, limiting consideration to successful queries only (i.e., queries that return one or more results at block 1120, with queries that return zero results being excluded from consideration for index generation), a number of times the query is repeated (e.g., blocks 1100-1120 must occur a threshold number of times in a given period for different queries), a cardinality of the set of intermediate search result values (e.g., build an index if cardinality is 1:N whereby a single value in the first search at block 1105 produces N values in the second search at block 1110, or N:1, whereby N values in the first search at block 1105 produce a single value in the second search at block 1110, but not for cardinality N:M, whereby N values in the first search at block 1105 produce M values in the second search at block 1110) or any combination thereof. If the semi-structured database server 170 determines not to build the index at block 1125, the process returns to block 1100. However, if the semi-structured database server 170 determines to build the index at block 1125, the semi-structured database server 170 builds an index that links the first set of search parameters for a given search directly to the set of second search result values obtained at block 1115, in block 1130. For example, the index generated at block 1130 can function as an instruction for future queries containing the first set of search parameters to simply use the index to obtain the final result data obtained at block 1115 without having to obtain the set of intermediate search values at block 1105 as part of the first search execution. In this manner, the unindexed lookups discussed above with respect to block 1010 of FIG. 10 can be skipped via use of the index in block 1130 (e.g., where block 1105 of FIG. 10 corresponds generally to 1100, block 1010 of FIG. 10 corresponds generally to block 1105 and 1015 of FIG. 10 corresponds generally to blocks 1115 and 1120). In an example, the index generated at block 1130 can be cached in the cache memory of the semi-structured database server 170 for quick access.

In a further example, the indexes generated at block 1130 can be selectively pruned based on a variety of factors, such as lack of use, reduced memory availability at the semi-structured database server 170 (e.g., in the cache memory, in main memory, etc.) or any combination thereof. For example, the semi-structured database server 170 may, if a threshold amount of time has elapsed without a particular index being used, delete the index. In another example, a low-memory condition at the semi-structured database server 170 (e.g., in the cache memory, in the main memory, etc.) can trigger deletion of some or all of the indexes so as to free up memory at the semi-structured database server 170. In a further example, a combination of memory availability and infrequency of use can be used to selectively delete some or all of the indexes generated at block 1130. For example, the semi-structured database server 170 can detect a low-memory condition and can then attempt to identify the least-used index generated at block 1130 for selective deletion.

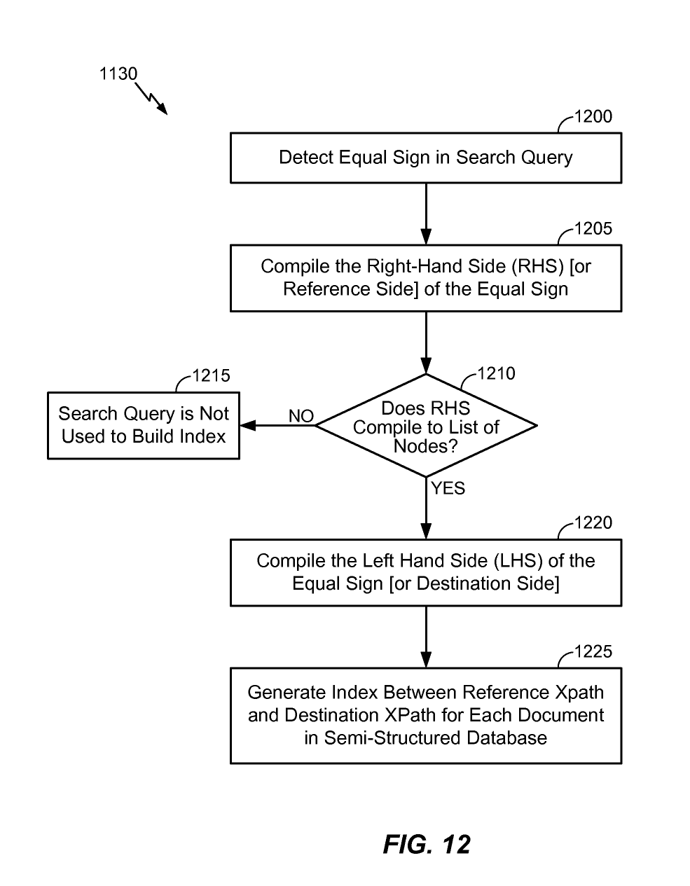

FIG. 12 illustrates an XML-specific implementation example that explains one way in which a particular search query that includes one or more reference (or pointer) parameters can be converted into an index in accordance with an embodiment of the disclosure. FIG. 12 generally corresponds to execution block 1130 of FIG. 11, although some aspects of FIG. 11 rely upon data obtained during a search query as part of blocks 1100-1120.

Referring to FIG. 12, the semi-structured database server 170 detects an equal sign in a search query, such as XPath query/document[@id=/document[@id=“A”]/citations/ref], in block 1200. The semi-structured database server 170 compiles (or looks up) the RHS of the equal sign, in block 1205, which is /document[@id=“A”]/citations/ref from the above-noted example. At block 1210, the semi-structured database server 170 evaluates the results of the compiling from block 1205 to determine if the RHS compiles to a list of nodes. If the RHS does not compile to a list of nodes, then the search query is not used to build an index, in block 1215. In an example, the RHS not compiling to a list of nodes infers that the RHS content is not a pointer (or reference). Otherwise, if the semi-structured database server 170 determines that the RHS compiles to a list of nodes at block 1210, the process advances to block 1220. In FIG. 11, the determination from block 1210 can be considered a component of block 1125. At block 1220, the semi-structured database server 170 compiles (or looks up) the LHS of the equal sign (or destination side), which is/document/@id from the above-noted example. The semi-structured database server 170 then generates an index between the reference XPath (“/document[@id=”A”]/citations/ref”) and the destination XPath (“/document/@id”) for each document in the semi-structured database, in block 1225.

TABLE 29
Ref to ID Index

| Context Path, | | Destination Doc ID, |
|---|---|---|
| Value | Doc ID, Start, End, Depth | Start, End, Depth |
| /document/@id, A | (A, 1, 2, 1) | |
| /document/@id, B | (B, 1, 2, 1) | |
| /document/citations/ref | (A, 4, 5, 2) | (B, 1, 2, 1) |
| | (A, 6, 7, 2) | |
| | (B, 4, 5, 2) | |
| | (B, 6, 7, 2) | |

As shown in Table 29, the index stores the location of the node containing the reference (in this case a <ref> element), as well as the location of the identifier node (in this case the id attribute).

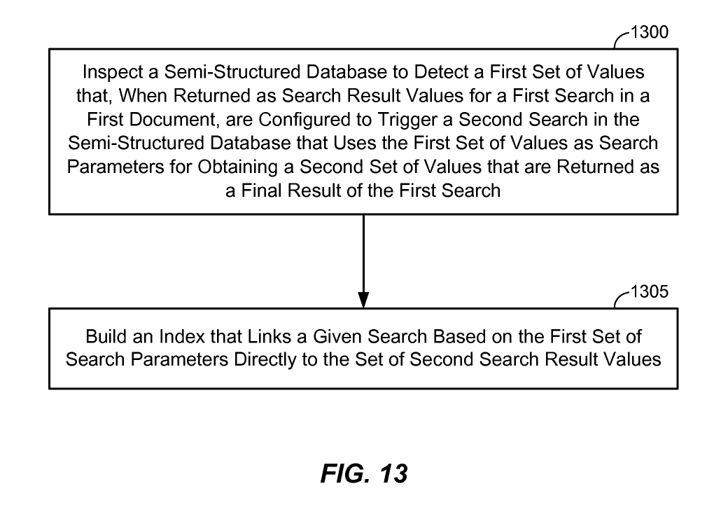

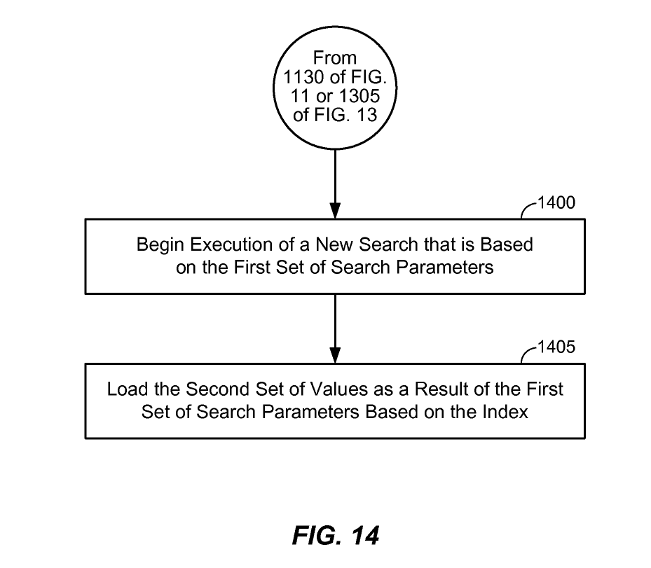

While FIG. 11 is directed to inspection of a number of queries to generate the indexes for one or more references, it is also possible that one or more documents in the semi-structured database can be inspected or scan to identify references (or pointers) in a more preemptive manner, as described below with respect to FIG. 13.

FIG. 13 illustrates a process of building an index for a reference (or pointer) based upon inspection of the semi-structured database in accordance with an embodiment of the disclosure. At block 1300, the semi-structured database server 170 inspects the semi-structured database to detect a first set of values that, when returned as search result values for a first search in a first document, are configured to trigger a second search in the semi-structured database that uses the first set of values as search parameters for obtaining a second set of values that are returned as a final result of the first search, which is similar in some respects to blocks 1100-1120 without an actual search query. Based on the inspection of block 1300, the semi-structured database server 170 builds an index at block 1305 in a similar manner to block 1130 of FIG. 11, which will not be described further for the sake of brevity.

Regarding the inspection in block 1300, a set of values can be analyzed in association with the various paths at which each value is located in a set of documents of the semi-structured database, for example:

TABLE 31
Value-Based Reference Inspection

| Value | (DocID, Path) |
|---|---|
| Brown | (41, /document/id), |
| | (43, /reference/id), |
| | (47, /reference/id), |
| | (50, /reference/id), |
| | . . . |
| Paddon | (42, /document/id), |
| | . . . |

Referring to Table 31, there is one document that indexes “Brown” at/document/id while there are multiple documents that index “Brown” at/reference/id, which is suggestive that “Brown” is used as a document identifier in document #41, and is otherwise used as a reference (or pointer) to document #41 when “Brown” is indexed to/reference/id in the other documents. From a semantic standpoint, the element or node name of “id” also can be interpreted as suggestive of a link. Rules for forming semantic relationships, or node classifications (e.g., reference node, etc.), are described in more detail below with respect to FIG. 14.

FIG. 14 illustrates an example continuation of the processes of FIG. 11 or FIG. 13 in accordance with an embodiment of the disclosure. Referring to FIG. 14, the semi-structured database server 170 begins a new search that is based on the first set of search parameters, in block 1400. Instead of obtaining the intermediate search values and then looking up the reference, the semi-structured database server 170 instead returns the second set of values as a result of the first set of search parameters based on the index generated at block 1130 of FIG. 11 or block 1305 of FIG. 13, in block 1405.

In an XML-specific example implementation of the process of FIG. 11, the following XPath query may be received at the semi-structured database server 170:

```
for $val in //lexisnexis-patent-document[
      .//publication-reference/document-id/doc-number=8577809]//
            patcit/document-id/doc-number
      return //lexisnexis-patent-document//publication-reference[
            document-id/doc-number=$val]/invention-title
```

The above-noted XPath query requires a join to be performed on two elements. The database would typically count such joins and dynamically store a join-index based on the citation-to-document-id mapping. By the execution of the above-noted XPath query, the semi-structured database server 170 can detect that the value(s) from one document were looked up and then values in another document were looked up, which can be a trigger to build the index, similar to block 1125 of FIG. 11. Alternatively, the indexes of the semi-structured database can be analyzed for certain patterns (e.g., detection of simple valued nodes whose content recurs across multiple documents, but under at least two different paths, semantic inspection of node names or partial paths can be used as a hint when searching for such potential edges, such as when the ref and id paths end with “document-id” or “doc-number”, inspection of node values to help determine the relationship of reference, and node or document identifier relationships, etc.), as described above with respect to FIG. 13. For example, the id path is in general more likely to have unique values within the document collection, while the ref is more often to see duplicated values.

While the processes are described as being performed by the semi-structured database server 170, as noted above, the semi-structured database server 170 can be implemented as a client device, a network server, an application that is embedded on a client device and/or network server, and so on. Hence, the apparatus that executes the processes in various example embodiments is intended to be interpreted broadly.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the disclosure, it should be noted that various changes and modifications could be made herein without departing from the scope of the disclosure as defined by the appended claims. The functions, steps and/or actions of the method claims in accordance with the embodiments of the disclosure described herein need not be performed in any particular order. Furthermore, although elements of the disclosure may be described or claimed in the singular, the plural is contemplated unless limitation to the singular is explicitly stated.

What is claimed is:

1. A method of performing a search within a semi-structured database that is storing a set of documents, each document in the set of documents being organized with a tree-structure that contains a plurality of nodes, the plurality of nodes for each document in the set of documents including a root node and at least one non-root node, each of the plurality of nodes including a set of node-specific data entries, comprising:
obtaining a series of search queries directed to a given target node of a given document among the set of documents;
categorizing a first set of search parameters in the series of search queries as frequently recurring parameters;
generating a partial search query template that is populated with shortcut information related to the first set of search parameters;
receiving a new search query that is directed to the given target node of the given document;
detecting that the new search query includes the first set of search parameters;
loading the partial search query template in response to the detecting; and
updating the loaded partial search query template to include one or more additional search parameters that are separate from the first set of search parameters and are specified in the new search query.

2. The method of claim 1, wherein the shortcut information related to the first set of search parameters includes join results from one or more previous lookup operations performed on the first set of search parameters in the series of search queries.

3. The method of claim 1, further comprising:
categorizing a second set of search parameters in the series of search queries as infrequently recurring parameters.

4. The method of claim 3, wherein the generating omits shortcut information related to the second set of search parameters from the partial search query template.

5. The method of claim 1, further comprising:
deleting at least a portion of the shortcut information from the partial search query template based on (i) re-categorizing one or more search parameters associated with the deleted portion of the shortcut information as infrequently recurring parameters, (ii) an available memory level dropping below a memory threshold and/or (iii) any combination thereof.

6. The method of claim 1, further comprising:
deleting the partial search query template based on (i) re-categorizing one or more search parameters associated with the shortcut information as infrequently recurring parameters, (ii) an available memory level dropping below a memory threshold and/or (iii) any combination thereof.

7. The method of claim 1,
wherein the series of search queries and the new search query are each received from the same client device, or
wherein two or more search queries of the series of search queries and the new search query are received from different client devices.

8. The method of claim 1, wherein the semi-structured database is an Extensible Markup Language (XML) database or a JavaScript Object Notation (JSON) database.

9. The method of claim 1, wherein the semi-structured database is implemented at a network server or a user equipment (UE).

10. The method of claim 1, further comprising:
executing the new search query using the updated partial search query template.

11. A server that is configured to perform a search within a semi-structured database that is storing a set of documents, each document in the set of documents being organized with a tree-structure that contains a plurality of nodes, the plurality of nodes for each document in the set of documents including a root node and at least one non-root node, each of the plurality of nodes including a set of node-specific data entries, comprising:
logic configured to obtain a series of search queries directed to a given target node of a given document among the set of documents;
logic configured to categorize a first set of search parameters in the series of search queries as frequently recurring parameters;
logic configured to generate a partial search query template that is populated with shortcut information related to the first set of search parameters;
logic configured to receive a new search query that is directed to the given target node of the given document;
logic configured to detect that the new search query includes the first set of search parameters;
logic configured to load the partial search query template in response to the detection; and
logic configured to update the loaded partial search query template to include one or more additional search parameters that are separate from the first set of search parameters and are specified in the new search query.

12. The server of claim 11, wherein the shortcut information related to the first set of search parameters includes join results from one or more previous lookup operations performed on the first set of search parameters in the series of search queries.

13. The server of claim 11, further comprising:
categorizing a second set of search parameters in the series of search queries as infrequently recurring parameters.

14. The server of claim 13, wherein the generating omits shortcut information related to the second set of search parameters from the partial search query template.

15. The server of claim 11, further comprising:
deleting at least a portion of the shortcut information from the partial search query template based on (i) re-categorizing one or more search parameters associated with the deleted portion of the shortcut information as infrequently recurring parameters, (ii) an available memory level dropping below a memory threshold and/or (iii) any combination thereof.

16. The server of claim 11, further comprising:
deleting the partial search query template based on (i) re-categorizing one or more search parameters associated with the shortcut information as infrequently recurring parameters, (ii) an available memory level dropping below a memory threshold and/or (iii) any combination thereof.

17. The server of claim 11,
wherein the series of search queries and the new search query are each received from the same client device, or
wherein two or more search queries of the series of search queries and the new search query are received from different client devices.

18. The server of claim 11, further comprising:
logic configured to execute the new search query using the updated partial search query template.

19. A method of performing a search within a semi-structured database that is storing a set of documents, each document in the set of documents being organized with a tree-structure that contains a plurality of nodes, the plurality of nodes for each document in the set of documents including a root node and at least one non-root node, each of the plurality of nodes including a set of node-specific data entries, comprising:
beginning execution of a first search among the set of documents in the semi-structured database that is based on a first set of search parameters;
obtaining, during the first search, a set of intermediate search result values;
detecting that the first search requires execution of a second search that uses the set of intermediate search result values as a second set of search parameters for the second search;
executing the second search in the semi-structured database using the set of intermediate search result values to obtain a set of second search result values;
returning the set of second search result values as a final result of the first search;
determining that the beginning, obtaining, detecting, executing and returning have occurred a threshold number of times; and
building, in response to the determining, an index that links a given search based on the first set of search parameters directly to the set of second search result values.

20. The method of claim 19,
wherein the first search and the second search are conducted in a first document, or
wherein the first search is conducted in the first document and the second search is conducted in a second document.

21. The method of claim 19, wherein the determining excludes any searches that do not return at least one search result from counting towards the threshold.

22. The method of claim 19, wherein the building is further based upon a cardinality between numbers of search results within the set of intermediate search result values and the set of second search result values.

23. The method of claim 19, wherein the semi-structured database is an Extensible Markup Language (XML) database or JavaScript Object Notation (JSON) database.

24. The method of claim 19, further comprising:
beginning execution of a new search in the semi-structured database that is based on the first set of search parameters; and
returning the set of second search result values as a result of the new search without first obtaining the set of intermediate search result values based on the index.

25. The method of claim 19, wherein the semi-structured database is implemented at a network server or a user equipment (UE).

26. A method of performing a search within a semi-structured database that is storing a set of documents, each document in the set of documents being organized with a tree-structure that contains a plurality of nodes, the plurality of nodes for each document in the set of documents including a root node and at least one non-root node, each of the plurality of nodes including a set of node-specific data entries, comprising:
inspecting the semi-structured database to detect a first set of values that, when returned as search result values for a first search in a first document among the set of documents, are configured to trigger a second search in the semi-structured database that uses the first set of values as search parameters for obtaining a second set of values that are returned as a final result of the first search; and
building an index that links a given search directed to the first set of values directly to the second set of values.

27. The method of claim 26,
wherein the first and second sets of values are in the first document, or
wherein the first set of values is in the first document and the second set of values is conducted in a second document.

28. The method of claim 26, further comprising:
beginning execution of a new search in the semi-structured database that is configured with search parameters that request the first set of values; and
returning the second set of values as a result of the new search without first obtaining the first set of values based on the index.

29. The method of claim 26, wherein the semi-structured database is an Extensible Markup Language (XML) database or a JavaScript Object Notation (JSON) database.

30. The method of claim 26, wherein the server corresponds to a network server or a user equipment (UE).
